(19) United States
(12) Patent Application Publication
(10) Pub. No.: US 2013/0253892 A1
(43) Pub. Date: Sep. 26, 2013

(54) CREATING SYNTHETIC EVENTS USING GENETIC SURPRISAL DATA REPRESENTING A GENETIC SEQUENCE OF AN ORGANISM WITH AN ADDITION OF CONTEXT

(71) Applicants: Robert R. Friedlander, Southbury, CT (US); James R. Kraemer, Santa Fe, NM (US)

(72) Inventors: Robert R. Friedlander, Southbury, CT (US); James R. Kraemer, Santa Fe, NM (US)

(73) Assignee: INTERNATIONAL BUSINESS MACHINES CORPORATION, Armonk, NY (US)

(21) Appl. No.: 13/557,631

(22) Filed: Jul. 25, 2012

Related U.S. Application Data
(63) Continuation-in-part of application No. 13/428,146, filed on Mar. 23, 2012.
Application No. 13/428,146 is a continuation-in-part of application No. 13/428,339, filed on Mar. 23, 2012.

(51) Int. Cl. G06G 7/48

(52) U.S. Cl. 703/11

(57) ABSTRACT

A method, program product and system creating synthetic events using genetic surprisal data representing a genetic sequence of an organism with an addition of context, comprising: if the reference genome used to generate the genetic surprisal data for each of the at least two organisms is different: retrieving each of the reference genomes and dividing each of the reference genomes into pieces corresponding to the genetic surprisal data of the organisms; and combining the pieces of the reference genomes together to form a single reference genome. Synthetic events are created based on searching the genetic surprisal data for at least one attribute repeated at a frequency within the genetic surprisal data of the organisms and organism records, optimizing the genetic surprisal data through clustering defined by at least one parameter; and forming at least two cohorts, a control cohort and a treatment cohort based on optimization of the surprisal data.

### CROSS-REFERENCE TO RELATED APPLICATIONS

This is a continuation-in-part patent application of copending application Ser. No. 13/428,146, filed Mar. 23, 2012, entitled “SURPRISAL DATA REDUCTION OF GENETIC DATA FOR TRANSMISSION, STORAGE AND ANALYSIS” and of copending application Ser. No. 13/428,339, filed Mar. 23, 2012, entitled “PARALLELIZATION OF SURPRISAL DATA REDUCTION AND GENOME CONSTRUCTION FROM GENETIC DATA FOR TRANSMISSION, STORAGE AND ANALYSIS”. The aforementioned applications are hereby incorporated herein by reference.

### BACKGROUND

The present invention relates to creating synthetic events using genetic surprisal data representing a genetic sequence of an organism, and more specifically to creating synthetic events using genetic surprisal data representing a genetic sequence of an organism with an addition of context.

A cohort is a group of individuals, machines, components, or modules identified by a set of one or more common characteristics. This group is studied over a period of time as part of a scientific study. A cohort may be studied for medical treatment, engineering, manufacturing, or for any other scientific purpose. A treatment cohort is a cohort selected for a particular action or treatment.

A control cohort is a group selected from a population that is used as the control. The control cohort is observed under ordinary conditions while another group is subjected to the treatment or other factor being studied. The data from the control group is the baseline against which all other experimental results must be measured. For example, a control cohort in a study of medicines for colon cancer may include individuals selected for specified characteristics, such as gender, age, physical condition, or disease state that do not receive the treatment.

The control cohort is used for statistical and analytical purposes. Particularly, the control cohorts are compared with action or treatment cohorts to note differences, developments, reactions, and other specified conditions. Control cohorts are heavily scrutinized by researchers, reviewers, and others that may want to validate or invalidate the viability of a test, treatment, or other research. If a control cohort is not selected according to scientifically accepted principles, an entire research project or study may be considered of no validity wasting large amounts of time and money. In the case of medical research, selection of a less than optimal control cohort may prevent proving the efficacy of a drug or treatment or incorrectly rejecting the efficacy of a drug or treatment. In the first case, billions of dollars of potential revenue may be lost. In the second case, a drug or treatment may be necessarily withdrawn from marketing when it is discovered that the drug or treatment is ineffective or harmful leading to losses in drug development, marketing, and even possible law suits.

Control cohorts are typically manually selected by researchers. Manually selecting a control cohort may be difficult for various reasons. For example, a user selecting the control cohort may introduce bias. Justifying the reasons, attributes, judgment calls, and weighting schemes for selecting the control cohort may be very difficult. Unfortunately, in many cases, the results of difficult and prolonged scientific research and studies may be considered unreliable or unacceptable requiring that the results be ignored or repeated. As a result, manual selection of control cohorts is extremely difficult, expensive, and unreliable.

An additional problem facing those in the art of data management is computationally explosive tasks. DNA gene sequencing of a human, for example, generates about 3 billion (3×10⁹) nucleotide bases. Genetics plays a large part in many studies. However, currently all 3 billion nucleotide base pairs are transmitted, stored and analyzed. The storage of the data associated with the sequencing is significantly large, requiring at least 3 gigabytes of computer data storage space to store the entire genome which includes only nucleotide sequenced data and no other data or information such as annotations. The movement of the data between institutions, laboratories and research facilities is hindered by the significantly large amount of data and the significant amount of storage necessary to contain the data.

Furthermore, comparison of sequences is computationally explosive and cumbersome. For example, comparing the entire genetic sequence of a single human to the genetic sequences of a million other humans would be considered computationally explosive. The problem of the computationally explosive comparison increases exponentially if the genetic sequences of a million humans are compared to the genetic sequences of a second, different million humans. The problem increases exponentially yet again when one desires to compare these factors to other factors, such as diet, environment, and ethnicity, to attempt to determine why certain humans live longer than others or why certain drugs may be more effective based on a patient's genetics.

### SUMMARY

According to one embodiment of the present invention a method of creating synthetic events using genetic surprisal data representing a genetic sequence of an organism with an addition of context. The method comprising the steps of: a computer retrieving genetic surprisal data from at least two organisms from a repository and an indication of a reference genome used to obtain the genetic surprisal data; if the reference genome used to generate the genetic surprisal data for each of the at least two organisms is different: the computer retrieving each of the reference genomes and dividing each of the reference genomes into pieces corresponding to the genetic surprisal data of the at least two organisms; the computer combining the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms; the computer searching the genetic surprisal data for at least one attribute repeated at a frequency within the genetic surprisal data of the at least two organisms and organism records; the computer optimizing the genetic surprisal data associated with the attribute repeated at a frequency within the genetic surprisal data of the at least two organisms and the organism records through clustering defined by at least one parameter; the computer forming at least two cohorts, a control cohort and a treatment cohort based on optimization of the genetic surprisal data; and the computer generating at least one synthetic event from the at least two cohorts.

According to another embodiment of the present invention, a computer program product for creating synthetic events using genetic surprisal data representing a genetic sequence of an organism with an addition of context. The computer program product comprising: one or more computer-readable, tangible storage devices; program instructions, stored on at least one of the one or more storage devices, to retrieve genetic surprisal data from at least two organisms from a repository and an indication of a reference genome used to obtain the genetic surprisal data; if the reference genome used to generate the genetic surprisal data for each of the at least two organisms is different: program instructions, stored on at least one of the one or more storage devices, to retrieve each of the reference genomes and divide each of the reference genomes into pieces corresponding to the genetic surprisal data of the at least two organisms; program instructions, stored on at least one of the one or more storage devices, to combine the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms; program instructions, stored on at least one of the one or more storage devices, to search the genetic surprisal data for at least one attribute repeated at a frequency within the genetic surprisal data of the at least two organisms and organism records; program instructions, stored on at least one of the one or more storage devices, to optimize the genetic surprisal data associated with the attribute repeated at a frequency within the genetic surprisal data of the at least two organisms and the organism records through clustering defined by at least one parameter; program instructions, stored on at least one of the one or more storage devices, to form at least two cohorts, a control cohort and a treatment cohort based on optimization of the genetic surprisal data; and program instructions, stored on at least one of the one or more storage devices, to generate at least one synthetic event from the at least two cohorts.

According to another embodiment of the present invention, a computer system for creating synthetic events using genetic surprisal data representing a genetic sequence of an organism with an addition of context. The computer system comprising: one or more processors, one or more computer-readable memories and one or more computer-readable, tangible storage devices; program instructions, stored on at least one of the one or more storage devices for execution by at least one of the one or more processors via at least one of the one or more memories, to retrieve genetic surprisal data from at least two organisms from a repository and an indication of a reference genome used to obtain the genetic surprisal data; if the reference genome used to generate the genetic surprisal data for each of the at least two organisms is different: program instructions, stored on at least one of the one or more storage devices for execution by at least one of the one or more processors via at least one of the one or more memories, to retrieve each of the reference genomes and divide each of the reference genomes into pieces corresponding to the genetic surprisal data of the at least two organisms; program instructions, stored on at least one of the one or more storage devices for execution by at least one of the one or more processors via at least one of the one or more memories, to combine the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms; program instructions, stored on at least one of the one or more storage devices for execution by at least one of the one or more processors via at least one of the one or more memories, to search the genetic surprisal data for at least one attribute repeated at a frequency within the genetic surprisal data of the at least two organisms and organism records; program instructions, stored on at least one of the one or more storage devices for execution by at least one of the one or more processors via at least one of the one or more memories, to optimize the genetic surprisal data associated with the attribute repeated at a frequency within the genetic surprisal data of the at least two organisms and the organism records through clustering defined by at least one parameter; program instructions, stored on at least one of the one or more storage devices for execution by at least one of the one or more processors via at least one of the one or more memories, to form at least two cohorts, a control cohort and a treatment cohort based on optimization of the genetic surprisal data; and program instructions, stored on at least one of the one or more storage devices for execution by at least one of the one or more processors via at least one of the one or more memories, to generate at least one synthetic event from the at least two cohorts.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of minimization of genetic data.

FIG. 3 shows a flowchart of a method of creating synthetic events using genetic surprisal data representing a genetic sequence of an organism with an addition of context.

FIG. 4 shows a flowchart of normalizing a reference genome for compilation and comparison of surprisal data into synthetic events.

FIG. 5 shows block diagram of a system for generating control cohorts in accordance with an illustrative embodiment.

FIGS. 6A-6B are graphical illustrations of clustering in accordance with an illustrative embodiment.

FIG. 7 is a block diagram illustrating information flow for feature selection in accordance with an illustrative embodiment.

FIG. 8 is a block diagram illustrating information flow for clustering records in accordance with an illustrative embodiment.

FIG. 9 is a block diagram illustrating information flow for clustering records for a potential control cohort in accordance with an illustrative embodiment.

FIG. 10 is a block diagram illustrating information flow for generating an optimal control cohort in accordance with an illustrative embodiment.

FIG. 11 is a process for optimal selection of control cohorts in accordance with an illustrative embodiment.

FIG. 12 is a block diagram of a system for providing medical information feedback to medical professionals, in accordance with an illustrative embodiment.

FIG. 13 is a block diagram of a dynamic analytical framework, in accordance with an illustrative embodiment.

FIG. 14 is a flowchart of a process for presenting medical information feedback to medical professionals, in accordance with an illustrative embodiment.

FIG. 15 shows is a block diagram illustrating combinations of cohorts to generate a synthetic event, in accordance with an illustrative embodiment.

FIG. 16 is a block diagram illustrating a combination of synthetic events, in accordance with an illustrative embodiment.

FIG. 17 is a block diagram illustrating processing of events in a processor having multi-threading processing capability, in accordance with an illustrative embodiment.

FIG. 18 is a flowchart of a process for generating synthetic events, in accordance with an illustrative embodiment.

FIG. 19 is a flowchart of a process for generating synthetic events, in accordance with an illustrative embodiment.

FIG. 20 illustrates internal and external components of a client computer and a server computer in which illustrative embodiments may be implemented.

### DETAILED DESCRIPTION

The illustrative embodiments of the present invention recognize that the difference between the genetic sequence from two humans is about 0.1%, which is one nucleotide difference per 1000 base pairs or approximately 3 million nucleotide differences. The difference may be a single nucleotide polymorphism (SNP) (a DNA sequence variation occurring when a single nucleotide in the genome differs between members of a biological species), or the difference might involve a sequence of several nucleotides. The illustrative embodiments recognize that most SNPs are neutral but some, approximately 3-5% are functional and influence phenotypic differences between species through alleles. Furthermore, approximately 10 to 30 million SNPs exist in the human population, of which at least 1% are functional. The illustrative embodiments also recognize that with the small amount of differences present between the genetic sequence from two humans, the “common” or “normally expected” sequences of nucleotides can be compressed out or removed to arrive at “surprisal data”—differences of nucleotides which are “unlikely” or “surprising” relative to the common sequences. The dimensionality of the data reduction that occurs by removing the “common” sequences is 10³, such that the number of data items and, more important, the interaction between nucleotides, is also reduced by a factor of approximately 10³—that is, to a total number of nucleotides remaining is on the order of 10³. The illustrative embodiments also recognize that by identifying what sequences are “common” or provide a “normally expected” value within a genome, and knowing what data is “surprising” or provides an “unexpected value” relative to the normally expected value.

The illustrative embodiments provide a computer implemented method, apparatus, and computer usable program code for creating synthetic events using genetic surprisal data representing a genetic sequence of an organism with an addition of context and optimization of genetic surprisal data control cohorts. Context is herein defined to be any information that can be used to characterize the situation of an entity. Results of a clustering process are used to calculate an objective function for selecting an optimal control cohort. A cohort is a group of individuals with common characteristics. Frequently, cohorts are used to test the effectiveness of medical treatments. Treatments are processes, medical procedures, drugs, actions, lifestyle changes, or other treatments prescribed for a specified purpose. A control cohort is a group of individuals that share a common characteristic that does not receive the treatment. The control cohort is compared against individuals or other cohorts that received the treatment to statistically prove the efficacy of the treatment.

The illustrative embodiments provide an automated method, apparatus, and computer usable program code for selecting individuals and their genetic surprisal data for a control cohort. To demonstrate a cause and effect relationship, an experiment must be designed to show that a phenomenon occurs after a certain treatment is given to a subject and that the phenomenon does not occur in the absence of the treatment. A properly designed experiment generally compares the results obtained from a treatment cohort against a control cohort which is selected to be practically identical. For most treatments, it is often preferable that the same number of individuals is selected for both the treatment cohort and the control cohort for comparative accuracy. The classical example is a drug trial. The cohort or group receiving the drug would be the treatment cohort, and the group receiving the placebo would be the control cohort. The difficulty is in selecting the two cohorts to be as near to identical as possible while not introducing human bias.

The illustrative embodiments provide an automated method, apparatus, and computer usable program code for selecting a genetic surprisal data control cohort. Because the features in the different embodiments are automated, the results are repeatable and introduce minimum human bias. The results are independently verifiable and repeatable in order to scientifically certify treatment results.

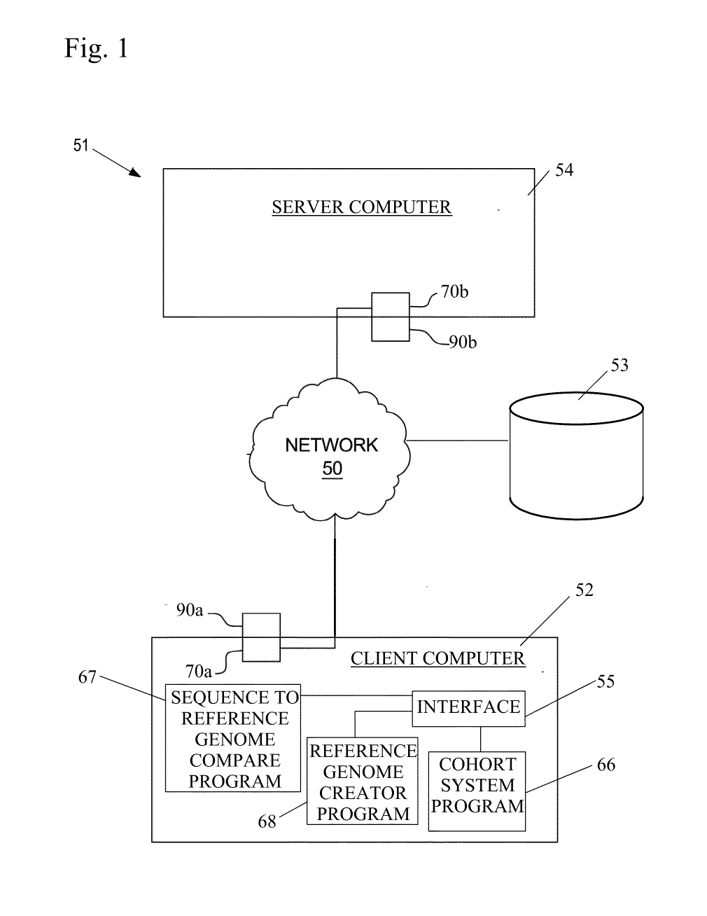

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

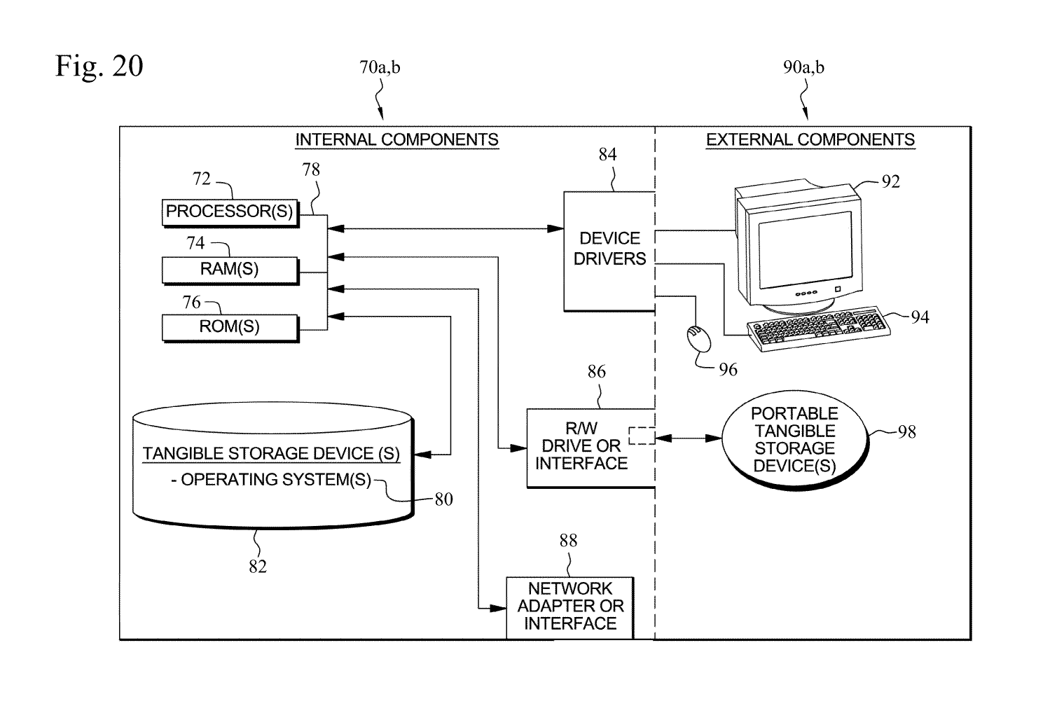

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 70a and a set of external components 90a, further illustrated in FIG. 20. The client computer 52 may be, for example, a mobile device, a cell phone, a personal digital assistant, a netbook, a laptop computer, a tablet computer, a desktop computer, a sequencing machine or any other type of computing device.

Client computer 52 may contain an interface 55. The interface can be, for example, a command line interface, a graphical user interface (GUI), or a web user interface (WUI). The interface may be used, for example for viewing cohorts, reference genomes, surprisal data, patient records, synthetic events and other information.

In the depicted example, server computer 54 provides information, such as boot files, operating system images, and applications to client computer 52. Server computer 54 can compute the information locally or extract the information from other computers on network 50. Server computer 54 includes a set of internal components 70b and a set of external components 90b illustrated in FIG. 20.

Program code and programs such as a sequence to reference genome compare program 67, a reference genome creator program 68, and/or a cohort system program 66 may be stored on at least one of one or more computer-readable tangible storage devices 830 shown in FIG. 20, on at least one of one or more portable computer-readable tangible storage devices 98 as shown in FIG. 20, or repository 53 connected to network 50, or downloaded to a data processing system or other device for use. For example, program code, sequence to reference genome compare program 67, a reference genome creator program 68, and/or a cohort system program 66 may be stored on at least one of one or more tangible storage devices 82 on server computer 54 and downloaded to client computer 52 over network 50 for use on client computer 52. Alternatively, server computer 54 can be a web server, and the program code and programs such as a sequence to reference genome compare program 67, a reference genome creator program 68, and/or a cohort system program 66 may be stored on at least one of the one or more tangible storage devices 82 on server computer 54 and accessed on client computer 52. A sequence to reference genome compare program 67, a reference genome creator program 68, and/or a cohort system program 66, can be accessed on client computer 52 through interface 55. In other exemplary embodiments, the program code, and programs such as sequence to reference genome compare program 67, a reference genome creator program 68, and/or a cohort system program 66 may be stored on at least one of one or more computer-readable tangible storage devices 82 on client computer 52 or distributed between two or more servers.

In the depicted example, network data processing system 51 is a combination of a number of computers and servers, with network 50 representing the Internet—a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

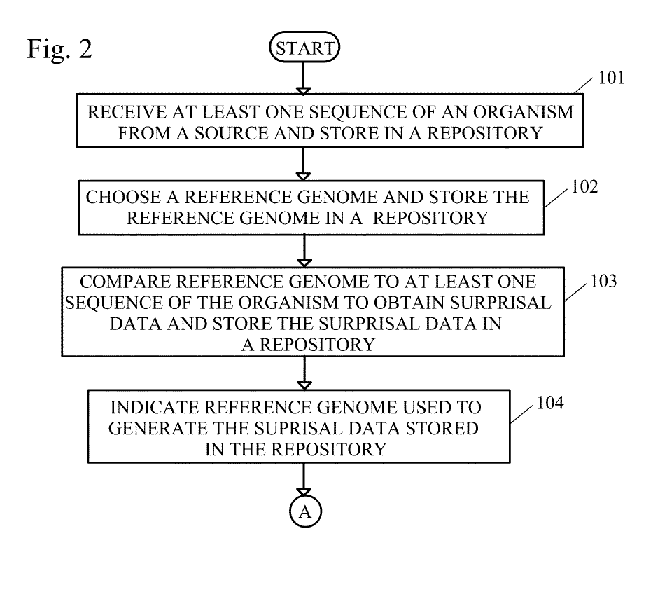

FIG. 2 shows a flowchart of a method of minimization of genetic data. In a first step, the sequence to reference genome compare program 67 receives at least one sequence of an organism from a source and stores the at least one sequence in a repository (step 101). The repository may be repository 53 as shown in FIG. 1. The source may be a sequencing device. The sequence may be a DNA sequence, an RNA sequence, or a nucleotide sequence. The organism may be a fungus, microorganism, human, animal or plant.

Based on the organism from which the at least one sequence is taken, the sequence to reference genome compare program 67 chooses and obtains at least one reference genome and stores the reference genome in a repository (step 102).

A reference genome is a digital nucleic acid sequence database which includes numerous sequences. The sequences of the reference genome do not represent any one specific individual's genome, but serve as a starting point for broad comparisons across a specific species, since the basic set of genes and genomic regulator regions that control the development and maintenance of the biological structure and processes are all essentially the same within a species. In other words, the reference genome is a representative example of a species' set of genes.

The reference genome may be tailored depending on the analysis that may take place after obtaining the surprisal data. For example, the sequence to reference genome compare program 67 can limit the comparison to specific genes of the reference genome, ignoring other genes or more common single nucleotide polymorphisms that may occur in specific populations of a species. The reference genome may also be chosen based on specific factors of the organism or patient such as ethnicity and geography.

The sequence to reference genome compare program 67 compares the at least one sequence to the reference genome to obtain surprisal data and stores only the surprisal data in a repository 53 (step 103). The surprisal data is defined as at least one nucleotide difference that provides an “unexpected value” relative to the normally expected value of the reference genome sequence. In other words, the surprisal data contains at least one nucleotide difference present when comparing the sequence to the reference genome sequence. The surprisal data that is actually stored in the repository preferably includes a location of the difference within the reference genome, the number of nucleic acid bases that are different, and the actual changed nucleic acid bases. Storing the number of bases which are different provides a double check of the method by comparing the actual bases to the reference genome bases to confirm that the bases really are different. With the surprisal data that is stored in step 103, the reference genome used to create the surprisal data is indicated (step 104).

For example, in the case of the human genome, which is 3 billion base pairs long and requires at least 3 gigabytes of computer data storage space, not including any other information such as annotations or other meta-data, the present invention reduces the size of the stored base pairs by 1,000 times to only 3 million surprisal base pairs, which may be stored in approximately 3 kilobytes worth of data storage, thus significantly reducing the amount computer data storage space needed. Other compression techniques well known in the art may be used in addition to compress the data. Furthermore, the genome of an organism or patient is reduced to the “surprising” data that may be relevant in studies of how the organism or patient reacts to certain treatment, drugs and diseases.

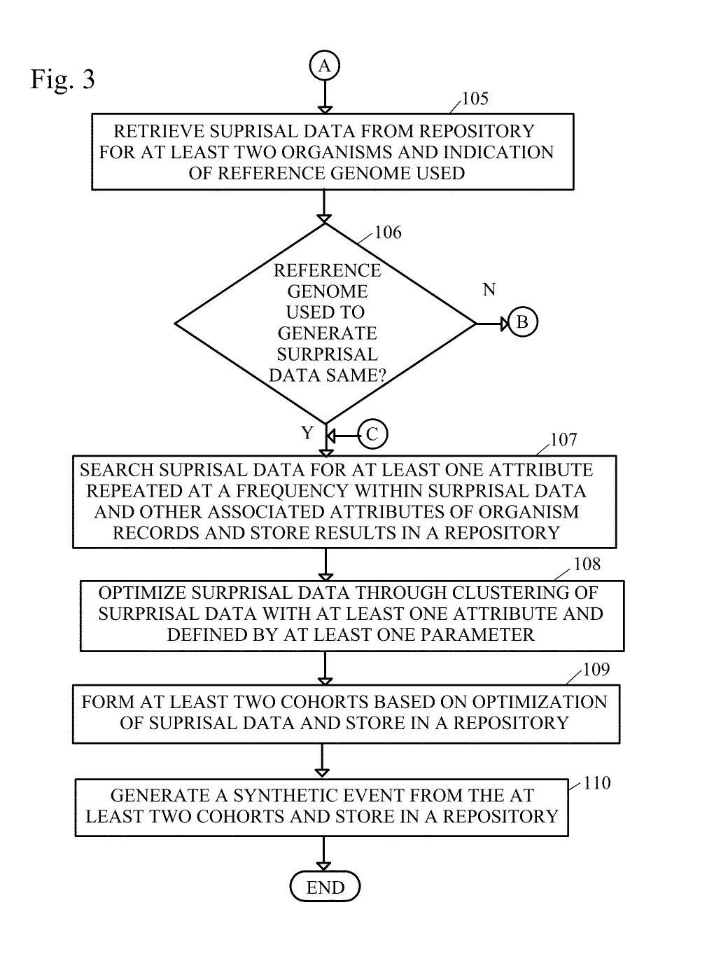

FIG. 3 shows a flowchart of a method of creating synthetic events using genetic surprisal data representing a genetic sequence of an organism with an addition of context. After the surprisal data has generated, for example using steps 101-104 in FIG. 2, the surprisal data and the indication of the reference genome used is retrieved from a repository for at least two organisms (step 105).

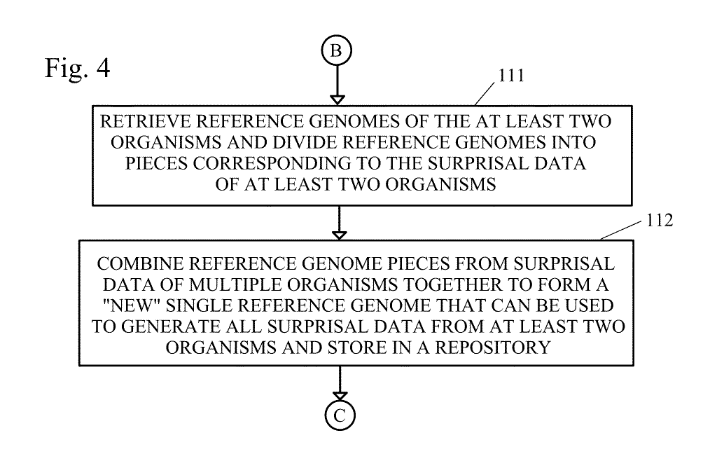

If the reference genome that is used to generate the surprisal data in each of the at least two organisms is not the same (step 106), the reference genomes of the at least two organisms are retrieved and the reference genomes are divided into pieces or parts corresponding to the surprisal data of the at least two organisms (step 111) as shown in FIG. 4. Then, the reference genome pieces from the surprisal data from the at least two organisms are combined together, to form a “new” single reference genome that can be used to generate all surprisal data from the at least two organisms and store in a repository (step 112) and proceed to step 107 shown in FIG. 3. Steps 111 and 112 may be carried out, for example using a reference genomic creator program 68 as shown in FIG. 1.

Referring back to FIG. 3, if the reference genome that is used to generate the surprisal data in each of the at least two organisms is the same (step 106), the surprisal data is searched for at least one attribute repeated at a frequency as well as other associated attributes of the organism's record (step 107). The attribute within the surprisal data could be the same nucleotide change at a specific location in gene. The attribute of the organism's record could be age, disease, or gender.

Steps 106 and 107 may be repeated as necessary, so that all organisms or patients being compared at one time use the same “new” reference genome to obtain surprisal data.

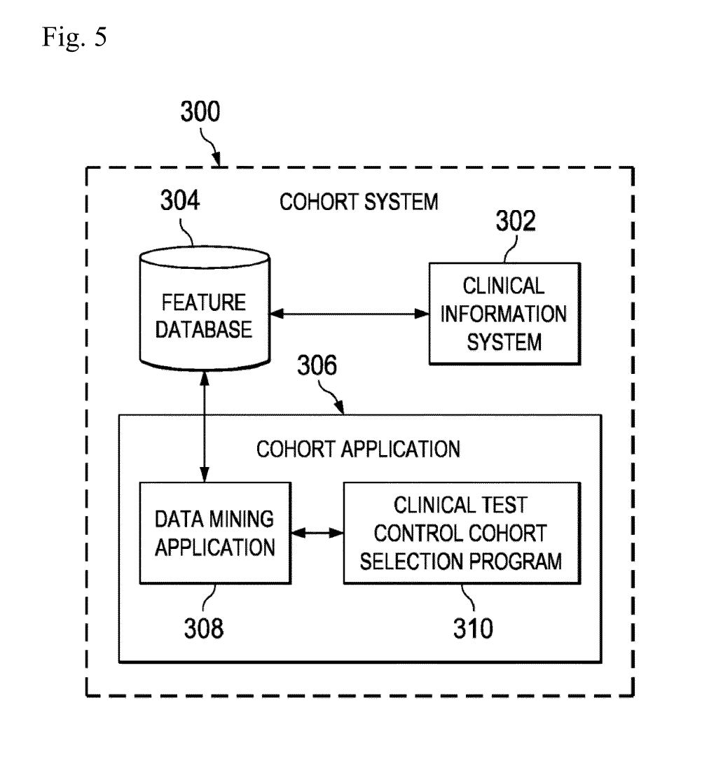

Based on the results of the search in step 107, the surprisal data is optimized into clusters defined by at least one parameter, for example using the cohort system program 66 shown in FIG. 1. The parameter can be associated with the surprisal data itself or that organism in which the surprisal data was based on (step 108). For example, age, geography, ethnicity, disease, health, etc. . . . . Based on the at least one parameter defined by the user and the optimization of the surprisal data into clusters, at least two cohorts, a treatment cohort and a control cohort are formed and stored in a repository (step 109). A synthetic event is then generated from the at least two cohorts and stored in a repository (step 110). Steps 108-110 are further described in FIGS. 5-19 below.

FIG. 5 shows a block diagram of a system for generating genetic surprisal data control cohorts in accordance with an illustrative embodiment. Cohort system 300 is a system for generating control cohorts and may use cohort system program 66 as shown in FIG. 1 to control and operate the cohort system and its associated elements and programs. Cohort system 300 includes clinical information system (CIS) 302, feature database 304, and cohort application 306. Each component of cohort system 300 may be interconnected via a network, such as network 50 of FIG. 1. Cohort application 306 further includes data mining application 308 and clinical test control cohort selection program 310.

Clinical information system 302 is a management system for managing patient data. This data may include, for example, demographic data, family health history data, vital signs, laboratory test results, drug treatment history, admission-discharge-treatment (ADT) records, co-morbidities, modality images, genetic data, surprisal genetic data and other patient data. Clinical information system 302 may be executed by a computing device, such as server computer 54 or client computer 52 of FIG. 1. Clinical information system 302 may also include information about a population of patients as a whole. Such information may disclose patients who have agreed to participate in medical research but who are not participants in a current study. Clinical information system 302 includes medical records for acquisition, storage, manipulation, and distribution of clinical information for individuals and organizations. Clinical information system 302 is scalable, allowing information to expand as needed. Clinical information system 302 may also include information sourced from pre-existing systems, such as pharmacy management systems, laboratory management systems, and radiology management systems.

Feature database 304 is a database in a repository, such as repository 53 of FIG. 1. Feature database 304 is populated with data from clinical information system 302. Feature database 304 includes patient data in the form of attributes. Attributes define features, variables, and characteristics of each patient. The most common attributes may include gender, age, disease or illness, and state of the disease. These attributes may be used in step 107 of FIG. 3 to search for frequency of occurrence in the patient population.

Cohort application 306 is a program for selecting control cohorts. Cohort application 306 is executed by a computing device, such as server computer 54 or client computer 52 of FIG. 1. Data mining application 308 is a program that provides data mining functionality on feature database 304 and other interconnected databases. In one example, data mining application 308 may be a program, such as DB2 Intelligent Miner produced by International Business Machines Corporation. Data mining is the process of automatically searching large volumes of data for patterns. Data mining may be further defined as the nontrivial extraction of implicit, previously unknown, and potentially useful information from data. Data mining application 308 uses computational techniques from statistics, information theory, machine learning, and pattern recognition.

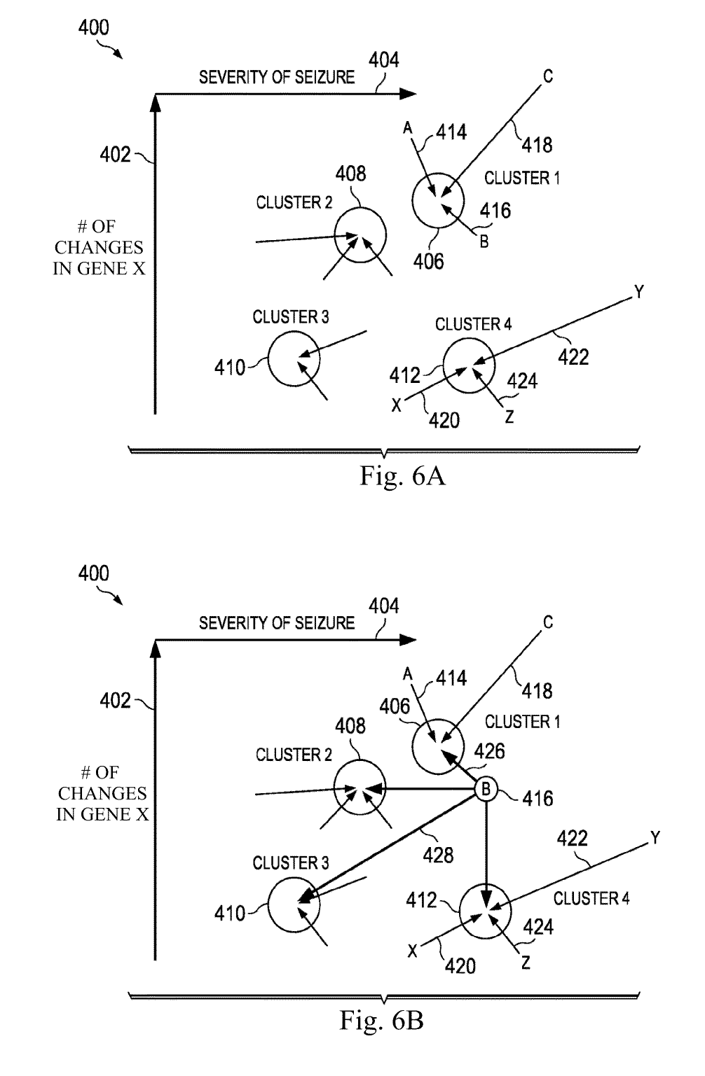

Particularly, data mining application 308 extracts useful information from feature database 304. Data mining application 308 allows users to select data, analyze data, show patterns, sort data, determine relationships, and generate statistics. Data mining application 308 may be used to cluster records in feature database 304 based on similar attributes, such as frequency of surprisal data at a specific location within the genome across multiple patients and may be used to implement steps 107 and 108 of FIG. 3. Data mining application 308 searches the records for attributes that most frequently occur in common and groups the related records or members accordingly for display or analysis to the user. This grouping process is referred to as clustering. The results of clustering show the number of detected clusters and the attributes that make up each cluster. Clustering is further described with respect to FIGS. 6a and 6b.

For example, data mining application 308 may be able to group patient records to show the effect of a new sepsis blood infection medicine. Currently, about 35 percent of all patients with the diagnosis of sepsis die. Patients entering an emergency department of a hospital who receive a diagnosis of sepsis, and who are not responding to classical treatments, may be recruited to participate in a drug trial. A statistical control cohort of similarly ill patients could be developed by cohort system 300, using records from historical patients, patients from another similar hospital, and patients who choose not to participate. Potential features to produce a clustering model could include age, co-morbidities, gender, surgical procedures, number of days of current hospitalization, O₂ blood saturation, blood pH, blood lactose levels, bilirubin levels, blood pressure, respiration, mental acuity tests, and urine output.

Data mining application 308 may use a clustering technique or model known as a Kohonen feature map neural network or neural clustering. Kohonen feature maps specify a number of clusters and the maximum number of passes through the data. The number of clusters must be between one and the number of records in the treatment cohort. The greater the number of clusters, the better the comparisons can be made between the treatment and the control cohort. Clusters are natural groupings of patient records based on the specified features or attributes. For example, a user may request that data mining application 308 generate eight clusters in a maximum of ten passes. The main task of neural clustering is to find a center for each cluster. The center is also called the cluster prototype. Scores are generated based on the distance between each patient record and each of the cluster prototypes. Scores closer to zero have a higher degree of similarity to the cluster prototype. The higher the score, the more dissimilar the record is from the cluster prototype.

All inputs to a Kohonen feature map must be scaled from 0.0 to 1.0. In addition, categorical values must be converted into numeric codes for presentation to the neural network. Conversions may be made by methods that retain the ordinal order of the input data, such as discrete step functions or bucketing of values. Each record is assigned to a single cluster, but by using data mining application 308, a user may determine a record's Euclidean dimensional distance for all cluster prototypes. Clustering is performed for the treatment cohort. Clinical test control cohort selection program 310 minimizes the sum of the Euclidean distances between the individuals or members in the treatment cohorts and the control cohort. Clinical test control cohort selection program 310 may incorporate an integer programming model, such as integer programming system 806 of FIG. 10. This program may be programmed in International Business Machine Corporation products, such as Mathematical Programming System eXtended (MPSX), the IBM Optimization Subroutine Library, or the open source GNU Linear Programming Kit. The illustrative embodiments minimize the summation of all records/cluster prototype Euclidean distances from the potential control cohort members to select the optimum control cohort.

FIGS. 6A-6B are graphical illustrations of clustering in accordance with an illustrative embodiment. Feature map 400 of FIG. 6A is a self-organizing map (SOM) and is a subtype of artificial neural networks. Feature map 400 is trained using unsupervised learning to produce low-dimensional representation of the training samples while preserving the topological properties of the input space. This makes feature map 400 especially useful for visualizing high-dimensional data, including cohorts and clusters.

In one illustrative embodiment, feature map 400 is a Kohonen Feature Map neural network. Feature map 400 uses a process called self-organization to group similar patient records together. Feature map 400 may use various dimensions. In this example, feature map 400 is a two-dimensional feature map including number of changes to gene X (e.g. surprisal data) 402 and severity of seizure 404. Feature map 400 may include as many dimensions as there are features, such as age, gender, genetic surprisal data, and severity of illness. Feature map 400 also includes cluster 1 406, cluster 2 408, cluster 3 410, and cluster 4 412. The clusters are the result of using feature map 400 to group individual patients based on the features. The clusters are self-grouped local estimates of all data or patients being analyzed based on competitive learning. When a training sample of patients is analyzed by data mining application 308 of FIG. 5, each patient is grouped into clusters where the clusters are weighted functions that best represent natural divisions of all patients based on the specified features.

The user may choose to specify the number of clusters and the maximum number of passes through the data. These parameters control the processing time and the degree of granularity used when patient records are assigned to clusters. The primary task of neural clustering is to find a center for each cluster. The center is called the cluster prototype. For each record in the input patient data set, the neural clustering data mining algorithm computes the cluster prototype that is the closest to the records. For example, patient record A 414, patient record B 416, and patient record C 418 are grouped into cluster 1 406. Additionally, patient record X 420, patient record Y 422, and patient record Z 424 are grouped into cluster 4 412.

FIG. 6B further illustrates how the score for each data record is represented by the Euclidean distance from the cluster prototype. The higher the score, the more dissimilar the record is from the particular cluster prototype. With each pass over the input patient data, the centers are adjusted so that a better quality of the overall clustering model is reached. To score a potential control cohort for each patient record, the Euclidian distance is calculated from each cluster prototype. This score is passed along to an integer programming system in clinical test control cohort selection program 310 of FIG. 5. The scoring of each record is further shown by integer programming system 806 of FIG. 10 below.

For example, patient B 416 is scored into the cluster prototype or center of cluster 1 406, cluster 2 408, cluster 3 410 and cluster 4 412. A Euclidean distance between patient B 416 and cluster 1 406, cluster 2 408, cluster 3 410 and cluster 4 412 is shown. In this example, distance 1 426, separating patient B 416 from cluster 1 406, is the closest. Distance 3 428, separating patient B 416 from cluster 3 410, is the furthest. These distances indicate that cluster 1 406 is the best fit.

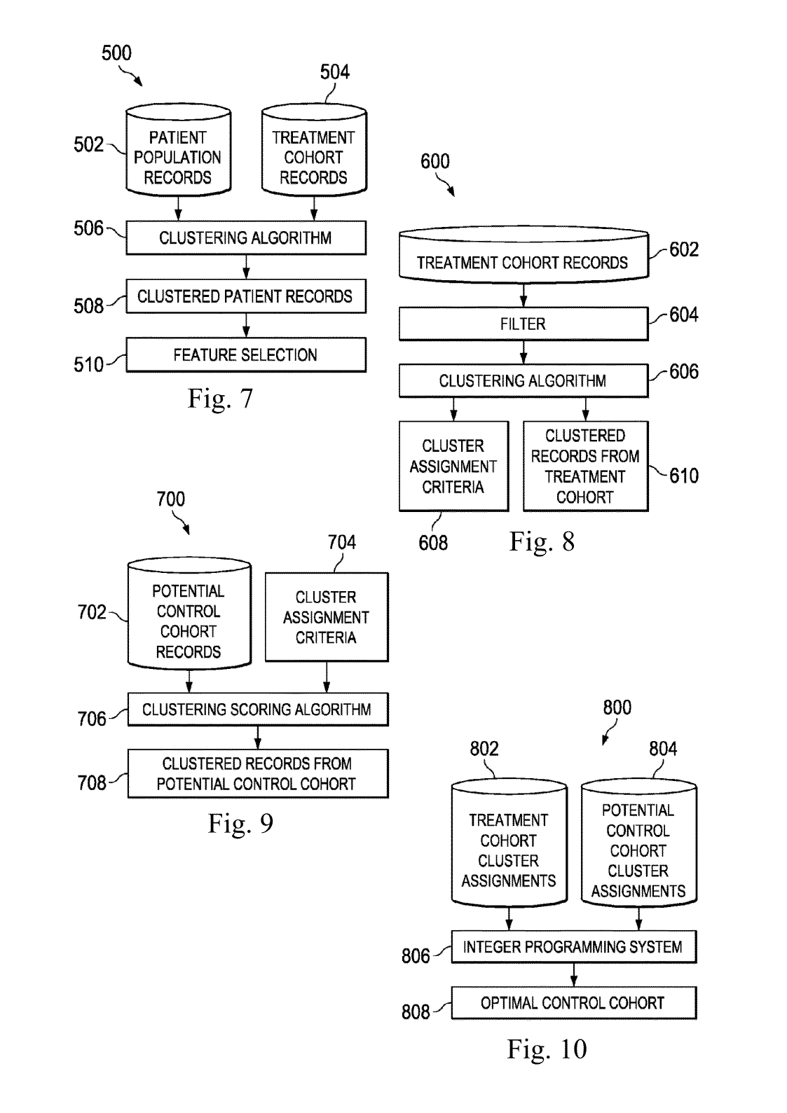

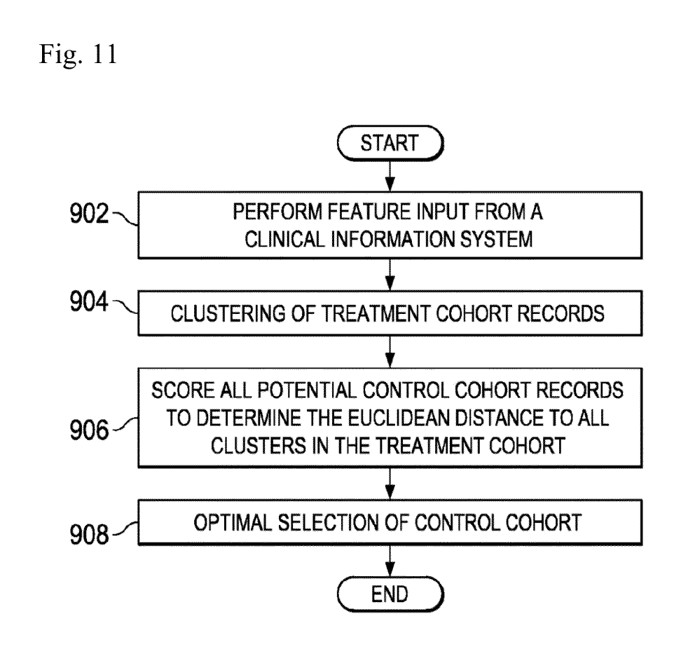

FIG. 7 is a block diagram illustrating information flow for feature selection in accordance with an illustrative embodiment. The block diagram of FIG. 7 may be implemented in cohort application 306 of FIG. 5. Feature selection system 500 includes various components and modules used to perform variable selection. The features selected are the features or variables that have the strongest effect in cluster assignment. For example, blood pressure and respiration may be more important in cluster assignment than patient gender. Feature selection system 500 may be used to perform step 902 of FIG. 11. Feature selection system 500 includes patient population records 502 with genetic surprisal data, treatment cohort records 504 with genetic surprisal data, clustering algorithm 506, clustered patient records 508, and produces feature selection 510.

Patient population records 502 are all records for patients who are potential control cohort members. Patient population records 502 and treatment cohort records 504 may be stored in a database or system, such as clinical information system 302 of FIG. 5 Treatment cohort records 504 are all records for the selected treatment cohort. The treatment cohort is selected based on the research, study, or other test that is being performed.

Clustering algorithm 506 uses the features from treatment cohort records 504 to group patient population records in order to form clustered patient records 508. Clustered patient records 508 include all patients grouped according to features of treatment cohort records 504. For example, clustered patient records 508 may be clustered by a clustering algorithm according to gender, age, physical condition, genetics, genetic surprisal data, disease, disease state, or any other quantifiable, identifiable, or other measurable attribute. Clustered patient records 508 are clustered using feature selection 510.

Feature selection 510 is the features and variables that are most important for a control cohort to mirror the treatment cohort. For example, based on the treatment cohort, the variables in feature selection 510 most important to match in the treatment cohort may be number of changes to gene X (surprisal data) 402 and severity of seizure 404 as shown in FIG. 6.

FIG. 8 is a block diagram illustrating information flow for clustering records in accordance with an illustrative embodiment. The block diagram of FIG. 8 may be implemented in cohort application 306 of FIG. 5. Cluster system 600 includes various components and modules used to cluster assignment criteria and records from the treatment cohort. Cluster system 600 may be used to perform step 904 of FIG. 11. Cluster system 600 includes treatment cohort records 602, filter 604, clustering algorithm 606, cluster assignment criteria 608, and clustered records from treatment cohort 610. Filter 604 is used to eliminate any patient records that have significant co-morbidities that would by itself eliminate inclusion in a drug trial. Co-morbidities are other diseases, illnesses, or conditions in addition to the desired features. For example, it may be desirable to exclude results from persons with more than one stroke from the statistical analysis of a new heart drug.

Treatment cohort records 602 are the same as treatment cohort records 504 of FIG. 7. Filter 604 filters treatment cohort records 602 to include only selected variables such as those selected by feature selection 510 of FIG. 7.

Clustering algorithm 606 is similar to clustering algorithm 506 of FIG. 7. Clustering algorithm 606 uses the results from filter 604 to generate cluster assignment criteria 608 and clustered records from treatment cohort 610. For example, patient A 414, patient B 416, and patient C 418 are assigned into cluster 1 406, all of FIGS. 6A-6B. Clustered records from treatment cohort 610 are the records for patients in the treatment cohort. Every patient is assigned to a primary cluster, and a Euclidean distance to all other clusters is determined. The distance is a distance, such as distance 426, separating patient B 416 and the center or cluster prototype of cluster 1 406 of FIG. 6B. In FIG. 6B, patient B 416 is grouped into the primary cluster of cluster 1 406 because of proximity. Distances to cluster 2 408, cluster 3 410, and cluster 4 412 are also determined.

FIG. 9 is a block diagram illustrating information flow for clustering records for a potential control cohort in accordance with an illustrative embodiment. The block diagram of FIG. 9 may be implemented in cohort application 306 of FIG. 5. Cluster system 700 includes various components and modules used to cluster potential control cohorts. Cluster system 700 may be used to perform step 906 of FIG. 11. Cluster system 700 includes potential control cohort records 702, cluster assignment criteria 704, clustering scoring algorithm 706, and clustered records from potential control cohort 708.

Potential control cohort records 702 are the records from patient population records, such as patient population records 502 of FIG. 7 that may be selected to be part of the control cohort. For example, potential control cohort records 702 do not include patient records from the treatment cohort. Clustering scoring algorithm 706 uses cluster assignment criteria 704 to generate clustered records from potential control cohort 708. Cluster assignment criteria are the same as cluster assignment criteria 608 of FIG. 8.

FIG. 10 is a block diagram illustrating information flow for generating an optimal control cohort in accordance with an illustrative embodiment. Cluster system 800 includes various components and modules used to cluster the optimal control cohort. Cluster system 800 may be used to perform step 908 of FIG. 11. Cluster system 800 includes treatment cohort cluster assignments 802, potential control cohort cluster assignments 804, integer programming system 806, and optimal control cohort 808. The cluster assignments indicate the treatment and potential control cohort records that have been grouped to that cluster.

0-1 Integer programming is a special case of integer programming where variables are required to be 0 or 1, rather than some arbitrary integer. The illustrative embodiments use integer programming system 806 because a patient is either in the control group or is not in the control group. Integer programming system 806 selects the optimum patients for optimal control cohort 808 that minimize the differences from the treatment cohort. The objective function of integer programming system 806 is to minimize the absolute value of the sum of the Euclidian distance of all possible control cohorts compared to the treatment cohort cluster prototypes. 0-1 Integer programming typically utilizes many well-known techniques to arrive at the optimum solution in far less time than would be required by complete enumeration. Patient records may be used zero or one time in the control cohort. Optimal control cohort 808 may be displayed in a graphical format to demonstrate the rank and contribution of each feature/variable for each patient in the control cohort.

FIG. 11 is a flowchart of a process for optimal selection of control cohorts in accordance with an illustrative embodiment. The process of FIG. 11 may be implemented in cohort system 300 of FIG. 5 and includes that steps that take place during step 109 of forming at least two cohorts based on optimization of genetic surprisal data of FIG. 1. The process first performs feature input from a clinical information system (step 902). In step 902, the process step moves every potential patient feature data stored in a clinical data warehouse, such as clinical information system 302 of FIG. 5. During step 902, many more variables are input than will be used by the clustering algorithm. These extra variables will be discarded by feature selection 510 of FIG. 7.

Some variables, such as age, genetic surprisal data, and gender, will need to be included in all clustering models. Other variables are specific to given diseases like Gleason grading system to help describe the appearance of the cancerous prostate tissue. Most major diseases have similar scales measuring the severity and spread of a disease. In addition to variables describing the major disease focus of the disease, most patients have co-morbidities. These might be conditions like diabetes, high blood pressure, stroke, or other forms of cancer. These co-morbidities may skew the statistical analysis so the control cohort must carefully select patients who well mirror the treatment cohort.

Next, the process clusters treatment cohort records (step 904). Next, the process scores all potential control cohort records to determine the Euclidean distance to all clusters in the treatment cohort (step 906). Step 904 and 906 may be performed by data mining application 308 based on data from feature database 304 and clinical information system 302 all of FIG. 5. Next, the process performs optimal selection of a control cohort (step 908) with the process terminating thereafter. Step 908 may be performed by clinical test control cohort selection program 310 of FIG. 5. The optimal selection is made based on the score calculated during step 906. The scoring may also involving weighting. For example, if a record is an equal distance between two clusters, but one cluster has more records the record may be clustered in the cluster with more records. During step 908, names, unique identifiers, or encoded indices of individuals in the optimal control cohort are displayed or otherwise provided.

In one illustrative scenario, a new protocol has been developed to reduce the risk of re-occurrence of congestive heart failure after discharging a patient from the hospital. A pilot program is created with a budget sufficient to allow 600 patients in the treatment and control cohorts. The pilot program is designed to apply the new protocol to a treatment cohort of patients at the highest risk of re-occurrence.

The clinical selection criteria for inclusion in the treatment cohort specifies that each individual: 1. Have more than one congestive heart failure related admission during the past year. 2. Have fewer than 60 days since the last congestive heart failure related admission. 3. Be 45 years or older. 4. Has surprisal data that occurs at a specific location in specified gene. Each of these attributes may be determined during feature selection of step 902. The clinical criteria yields 296 patients for the treatment cohort, so 296 patients are needed for the control cohort. The treatment cohort and control cohort are selected from patient records stored in feature database 304 or clinical information system 302 of FIG. 5.

Originally, there were 2,927 patients available for the study. The treatment cohort reduces the patient number to 2,631 unselected patients. Next, the 296 patients of the treatment cohort are clustered during step 904. The clustering model determined during step 904 is applied to the 2,631 unselected patients to score potential control cohort records in step 906. Next, the process selects the best matching 296 patients for the optimal selection of a control cohort in step 908. The result is a group of 592 patients divided between treatment and control cohorts who best fit the clinical criteria. The results of the control cohort selection are repeatable and defendable.

Thus, the illustrative embodiments provide a computer implemented method, apparatus, and computer usable program code for optimizing control cohorts. The control cohort is automatically selected from patient records to minimize the differences between the treatment cohort and the control cohort. The results are automatic and repeatable with the introduction of minimum human bias.

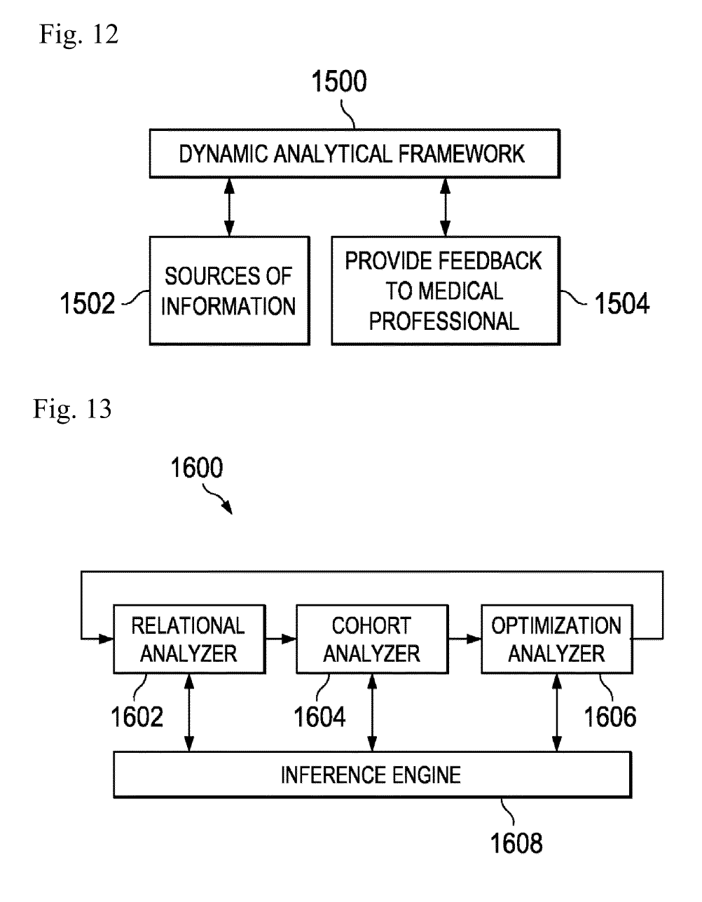

FIG. 12 is a block diagram of a system for providing medical information feedback to medical professionals, in accordance with an illustrative embodiment. The system shown in FIG. 12 can be implemented using one or more data processing systems, including but not limited to computing grids, server computers, client computers, network data processing system 51 in FIG. 1. Sources of information 1502 can be from one or more or different sources. Means for providing feedback to medical professionals 1504 can be any means for communicating or presenting information, including screenshots on displays, emails, computers, personal digital assistants, cell phones, pagers, or one or combinations of multiple data processing systems.

Dynamic analytical framework 1500 receives and/or retrieves data from sources of information 1502. Preferably, each chunk of data is grabbed as soon as a chunk of data is available. Sources of information 1502 can be continuously updated by constantly searching public sources of additional information, such as publications, journal articles, research articles, patents, patent publications, reputable Websites, and possibly many, many additional sources of information. Sources of information 1502 can include data shared through web tool mash-ups or other tools; thus, hospitals and other medical institutions can directly share information and provide such information to sources of information 1502.

Dynamic analytical framework 1500 evaluates (edits and audits), cleanses (converts data format if needed), scores the chunks of data for reasonableness, relates received or retrieved data to existing data, establishes cohorts, performs clustering analysis, performs optimization algorithms, possibly establishes inferences based on queries, and can perform other functions, all on a real-time basis. Some of these functions are described with respect to FIG. 13.

When prompted, or possibly based on some action trigger, dynamic analytical framework 1500 provides feedback to means for providing feedback to medical professionals 1504. Means for providing feedback to medical professionals 1504 can be a screenshot, a report, a print-out, a verbal message, a code, a transmission, a prompt, or any other form of providing feedback useful to a medical professional.

Means for providing feedback to medical professionals 1504 can re-input information back into dynamic analytical framework 1500. Thus, answers and inferences generated by dynamic analytical framework 1500 are re-input back into dynamic analytical framework 1500 and/or sources of information 1502 as additional data that can affect the result of future queries or cause an action trigger to be satisfied. For example, an inference drawn that an epidemic is forming is re-input into dynamic analytical framework 1500, which could cause an action trigger to be satisfied so that professionals at the Center for Disease Control can take emergency action.

Thus, dynamic analytical framework 1500 provides a supporting architecture and a means for providing digesting truly vast amounts of very detailed data and aggregating such data in a manner that is useful to medical professionals. Dynamic analytical framework 1500 provides a method for incorporating the power of set analytics to create highly individualized treatment plans by establishing relationships among data and drawing conclusions based on all relevant data. Dynamic analytical framework 1500 can perform these actions on a real time basis, and further can optimize defined parameters to maximize perceived goals. This process is described more with respect to FIG. 13.

When the illustrative embodiments are implemented across broad medical provider systems, the aggregate results can be dramatic. Not only does patient health improve, but both the cost of health insurance for the patient and the cost of liability insurance for the medical professional are reduced because the associated payouts are reduced. As a result, the real cost of providing medical care, across an entire medical system, can be reduced; or, at a minimum, the rate of cost increase can be minimized.

In an illustrative embodiment, dynamic analytical framework 1500 can be manipulated to access or receive information from only selected ones of sources of information 1502, or to access or receive only selected data types from sources of information 1502. For example, a user can specify that dynamic analytical framework 1500 should not access or receive data from a particular source of information. On the other hand, a user can also specify that dynamic analytical framework 1500 should again access or receive that particular source of information, or should access or receive another source of information. This designation can be made contingent upon some action trigger. For example, should dynamic analytical framework 1500 receive information from a first source of information, dynamic analytical framework 1500 can then automatically begin or discontinue receiving or accessing information from a second source of information. However, the trigger can be any trigger or event.

In a specific example, some medical professionals do not trust, or have lower trust of, patient-reported data. Thus, a medical professional can instruct dynamic analytical framework 1500 to perform an analysis and/or inference without reference to patient-reported data in sources of information 1502. However, to see how the outcome changes with patient-reported data, the medical professional can re-run the analysis and/or inference with the patient-reported data. Continuing this example, the medical professional designates a trigger. The trigger is that, should a particular unlikely outcome arise, then dynamic analytical framework 1500 will discontinue receiving or accessing patient-reported data, discard any analysis performed to that point, and then re-perform the analysis without patient-reported data—all without consulting the medical professional. In this manner, the medical professional can control what information dynamic analytical framework 1500 uses when performing an analysis and/or generating an inference.

In another illustrative embodiment, data from selected ones of sources of information 1502 and/or types of data from sources of information 1502 can be given a certain weight. Dynamic analytical framework 1500 will then perform analyses or generate inferences taking into account the specified weighting.

For example, the medical professional can require dynamic analytical framework 1500 to give patient-related data a low weighting, such as 0.5, indicating that patient-related data should only be weighted 50%. In turn, the medical professional can give DNA tests performed on those patients a higher rating, such as 2.0, indicating that DNA test data should count as doubly weighted. The analysis and/or generated inferences from dynamic analytical framework 1500 can then be generated or re-generated as often as desired until a result is generated that the medical professional deems most appropriate.

This technique can be used to aid a medical professional in deriving a path to a known result. For example, dynamic analytical framework 1500 can be forced to arrive at a particular result, and then generate suggested weightings of sources of data or types of data in sources of information 1502 in order to determine which data or data types are most relevant. In this manner, dynamic analytical framework 1500 can be used to find causes and/or factors in arriving at a known result.

FIG. 13 is a block diagram of a dynamic analytical framework, in accordance with an illustrative embodiment. Dynamic analytical framework 1600 is a specific illustrative example of dynamic analytical framework 1500. Dynamic analytical framework 1600 can be implemented using one or more data processing systems, including but not limited to computing grids, server computers, client computers, network data processing system 51 in FIG. 1.

Dynamic analytical framework 1600 includes relational analyzer 1602, cohort analyzer 1604, optimization analyzer 1606, and inference engine 1608. Each of these components can be implemented one or more data processing systems, including but not limited to computing grids, server computers, client computers, network data processing system 51 in FIG. 1, and can take entirely hardware, entirely software embodiments, or a combination thereof. These components can be performed by the same devices or software programs. These components are described with respect to their functionality, not necessarily with respect to individual identities.

Relational analyzer 1602 establishes connections between received or acquired data and data already existing in sources of information, such as source of information 1502 in FIG. 12. The connections are based on possible relationships amongst the data. For example, patient information in an electronic medical record is related to a particular patient. However, the potential relationships are countless. For example, a particular electronic medical record could contain information that a patient has a particular disease and was treated with a particular treatment. The disease particular disease and the particular treatment are related to the patient and, additionally, the particular disease is related to the particular patient. Generally, electronic medical records, agglomerate patient information in electronic healthcare records, data in a data mart or warehouse, or other forms of information are, as they are received, related to existing data in sources of information 1502, such as source of information 1502 in FIG. 12.

In an illustrative embodiment, using metadata, a given relationship can be assigned additional information that describes the relationship. For example, a relationship can be qualified as to quality. For example, a relationship can be described as “strong,” such as in the case of a patient to a disease the patient has, be described as “tenuous,” such as in the case of a disease to a treatment of a distantly related disease, or be described according to any pre-defined manner. The quality of a relationship can affect how dynamic analytical framework 1600 clusters information, generates cohorts, and draws inferences.

In another example, a relationship can be qualified as to reliability. For example, research performed by an amateur medical provider may be, for whatever reason, qualified as “unreliable” whereas a conclusion drawn by a researcher at a major university may be qualified as “very reliable.” As with quality of a relationship, the reliability of a relationship can affect how dynamic analytical framework 1600 clusters information, generates cohorts, and draws inferences.

Relationships can be qualified along different or additional parameters, or combinations thereof. Examples of such parameters included, but are not limited to “cleanliness” of data (compatibility, integrity, etc.), “reasonability” of data (likelihood of being correct), age of data (recent, obsolete), timeliness of data (whether information related to the subject at issue would require too much time to be useful), or many other parameters.

Established relationships are stored, possibly as metadata associated with a given datum. After establishing these relationships, cohort analyzer 1604 relates patients to cohorts (sets) of patients using clustering, heuristics, or other algorithms. Again, a cohort is a group of individuals, machines, components, or modules identified by a set of one or more common characteristics.

For example, a patient has diabetes. Cohort analyzer 1604 relates the patient in a cohort comprising all patients that also have diabetes. Continuing this example, the patient has type I diabetes and is given insulin as a treatment. Cohort analyzer 1604 relates the patient to at least two additional cohorts, those patients having type I diabetes (a different cohort than all patients having diabetes) and those patients being treated with insulin. Cohort analyzer 1604 also relates information regarding the patient to additional cohorts, such as a cost of insulin (the cost the patient pays is a datum in a cohort of costs paid by all patients using insulin), a cost of medical professionals, side effects experienced by the patient, severity of the disease, genetic surprisal data in a specific gene(s) and possibly many additional cohorts.

After relating patient information to cohorts, cohort analyzer 1604 clusters different cohorts according to the techniques described with respect to FIG. 5 through FIG. 11. Clustering is performed according to one or more defined parameters, such as treatment, outcome, cost, related diseases, patients with the same disease, and possibly many more. By measuring the Euclidean distance between different cohorts, a determination can be made about the strength of a deduction. For example, by clustering groups of patients having type I diabetes by severity, insulin dose, and outcome, the conclusion that a particular dose of insulin for a particular severity can be assessed to be “strong” or “weak.” This conclusion can be drawn by the medical professional based on presented cohort and clustered cohort data, but can also be performed using optimization analyzer 1606.

Optimization analyzer 1606 can perform optimization to maximize one or more parameters against one or more other parameters as takes place in step 108 shown in FIG. 3. For example, optimization analyzer 1606 can use mathematical optimization algorithms to establish a treatment plan with a highest probability of success against a lowest cost. Thus, simultaneously, the quality of healthcare improves, the probability of medical error decreases substantially, and the cost of providing the improved healthcare decreases. Alternatively, if cost is determined to be a lesser factor, then a treatment plan can be derived by performing a mathematical optimization algorithm to determine the highest probability of positive outcome against the lowest probability of negative outcome. In another example, all three of highest probability of positive outcome, lowest probability of negative outcome, and lowest cost can all be compared against each other in order to derive the optimal solution in view of all three parameters.

Continuing the example above, a medical professional desires to minimize costs to a particular patient having type I diabetes. The medical professional knows that the patient should be treated with insulin, but desires to minimize the cost of insulin prescriptions without harming the patient. Optimization analyzer 1606 can perform a mathematical optimization algorithm using the clustered cohorts to compare cost of doses of insulin against recorded benefits to patients with similar severity of type I diabetes at those corresponding doses. The goal of the optimization is to determine at what dose of insulin this particular patient will incur the least cost but gain the most benefit. Using this information, the doctor finds, in this particular case, that the patient can receive less insulin than the doctor's first guess. As a result, the patient pays less for prescriptions of insulin, but receives the needed benefit without endangering the patient.

In another example, the doctor finds that the patient should receive more insulin than the doctor's first guess. As a result, harm to the patient is minimized and the doctor avoided making a medical error using the illustrative embodiments.

Inference engine 1608 can operate with each of relational analyzer 1602, cohort analyzer 1604, and optimization analyzer 1606 to further improve the operation of dynamic analytical framework 1600. Inference engine 1608 is able to generate inferences, not previously known, based on a fact or query.

Inference engine 1608 can be used to improve performance of relational analyzer 1602. New relationships among data can be made as new inferences are made. For example, based on a past query or past generated inference, a correlation is established that a single treatment can benefit two different, unrelated conditions. A specific example of this type of correlation is seen from the history of the drug sildenafil citrate (1-[4-ethoxy-3-(6,7-dihydro-1-methyl-7-oxo-3-propyl-1H-pyrazolo[4,3-d]pyrimidin-5-yl)phenylsulfonyl]-4-methylpiperazine citrate). This drug was commonly used to treat pulmonary arterial hypertension. However, an observation was made that, in some male patients, this drug also improved problems with impotence. As a result, this drug was subsequently marketed as a treatment for impotence. Not only were certain patients with this condition treatment, but the pharmaceutical companies that made this drug were able to profit greatly.

Inference engine 1608 can draw similar inferences by comparing cohorts and clusters of cohorts to draw inferences. Continuing the above example, inference engine 1608 could compare cohorts of patients given the drug sildenafil citrate with cohorts of different outcomes. Inference engine 1608 could draw the inference that those patients treated with sildenafil citrate experienced reduced pulmonary arterial hypertension and also experienced reduced problems with impotence. The correlation gives rise to a probability that sildenafil citrate could be used to treat both conditions. As a result, inference engine 1608 could take two actions: 1) alert a medical professional to the correlation and probability of causation, and 2) establish a new, direct relationship between sildenafil citrate and impotence. This new relationship is stored in relational analyzer 1602, and can subsequently be used by cohort analyzer 1604, optimization analyzer 1606, and inference engine 1608 itself to draw new conclusions and inferences.

Similarly, inference engine 1608 can be used to improve the performance of cohort analyzer 1604. Based on queries, facts, or past inferences, new inferences can be made regarding relationships amongst cohorts. Additionally, new inferences can be made that certain objects should be added to particular cohorts. Continuing the above example, sildenafil citrate could be added to the cohort of “treatments for impotence.” The relationship between the cohort “treatments for impotence” and the cohort “patients having impotence” is likewise changed by the inference that sildenafil citrate can be used to treat impotence.

Similarly, inference engine 1608 can be used to improve the performance of optimization analyzer 1606. Inferences drawn by inference engine 1608 can change the result of an optimization process based on new information. For example, in an hypothetically speaking only, had sildenafil citrate been a less expensive treatment for impotence than previously known treatments, then this fact would be taken into account by optimization analyzer 1606 in considering the best treatment option at lowest cost for a patient having impotence.

Still further, inferences generated by inference engine 1608 can be presented, by themselves, to medical professionals through, for example, means for providing feedback to medical professionals 1504 of FIG. 12. In this manner, attention can be drawn to a medical professional of new, possible treatment options for patients. Similarly, attention can be drawn to possible causes for medical conditions that were not previously considered by the medical professional. Attention may also be drawn to the role genetics plays on why certain treatments will be effective or not. Such inferences can be ranked, changed, and annotated by the medical professional. Such inferences, including any annotations, are themselves stored in sources of information 1502. The process of data acquisition, query, relationship building, cohort building, cohort clustering, optimization, and inference can be repeated multiple times as desired to achieve a best possible inference or result. In this sense, dynamic analytical framework 1600 is capable of learning.

The illustrative embodiments can be further improved. For example, sources of information 1502 can include the details of a patient's insurance plan. As a result, optimization analyzer 1606 can maximize a cost/benefit treatment option for a particular patient according to the terms of that particular patient's insurance plan. Additionally, real-time negotiation can be performed between the patient's insurance provider and the medical provider to determine what benefit to provide to the patient for a particular condition.

Sources of information 1502 can also include details regarding a patient's lifestyle. For example, the fact that a patient exercises rigorously once a day can influence what treatment options are available to that patient.

Sources of information 1502 can take into account available medical resources at a local level or at a remote level. For example, treatment rankings can reflect locally available therapeutics versus specialized, remotely available therapeutics.

Sources of information 1502 can include data reflecting how time sensitive a situation or treatment is. Thus, for example, dynamic analytical framework 1500 will not recommend calling in a remote trauma surgeon to perform cardiopulmonary resuscitation when the patient requires emergency care.

Source of information 1502 can also include genetic surprisal data. For example, some treatments will be more effective for people with a specific genetic makeup than others.

Still further, information generated by dynamic analytical framework 1600 can be used to generate information for financial derivatives. These financial derivatives can be traded based on an overall cost to treat a group of patients having a certain condition, the overall cost to treat a particular patient, or many other possible derivatives.

In another illustrative example, the illustrative embodiments can be used to minimize false positives and false negatives. For, example, if a parameter along which cohorts are clustered are medical diagnoses, then parameters to optimize could be false positives versus false negatives. In other words, when the at least one parameter along which cohorts are clustered comprises a medical diagnosis, the second parameter can comprise false positive diagnoses, and the third parameter can comprise false negative diagnoses. Clusters of cohorts having those properties can then be analyzed further to determine which techniques are least likely to lead to false positives and false negatives.

When the illustrative embodiments are implemented across broad medical provider systems, the aggregate results can be dramatic. Not only does patient health improve, but both the cost of health insurance for the patient and the cost of liability insurance for the medical professional are reduced because the associated payouts are reduced. As a result, the real cost of providing medical care, across an entire medical system, can be reduced; or, at a minimum, the rate of cost increase can be minimized.

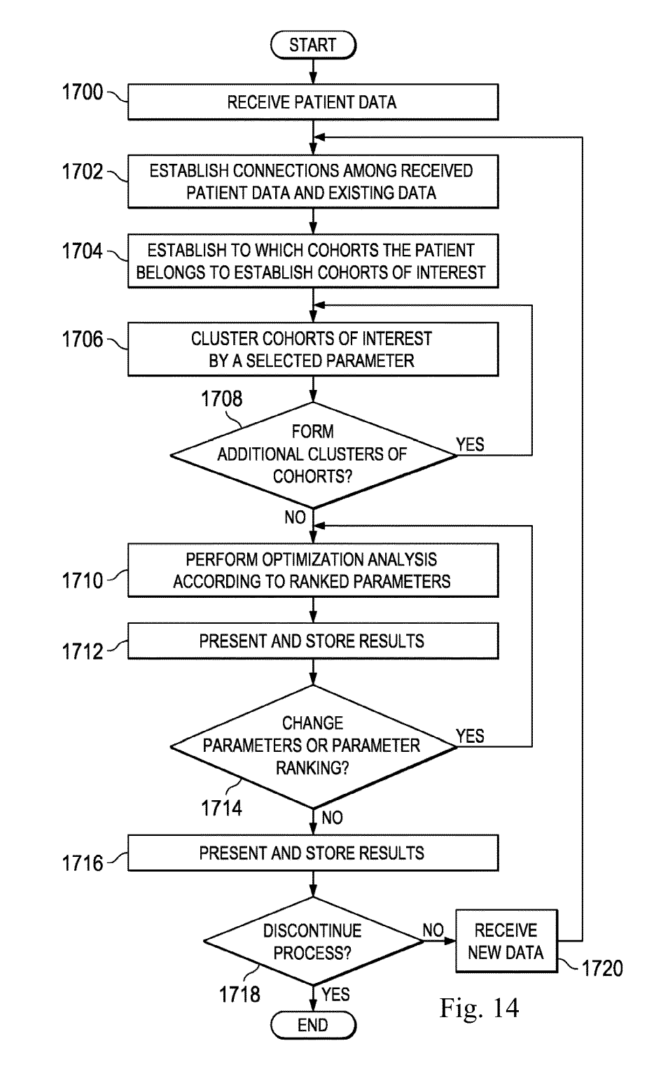

FIG. 14 is a flowchart of a process for presenting medical information feedback to medical professionals, in accordance with an illustrative embodiment. The process shown in FIG. 14 can be implemented using dynamic analytical framework 1500 in FIG. 12, and dynamic analytical framework 1600 in FIG. 13. Thus, the process shown in FIG. 14 can be implemented using one or more data processing systems, including but not limited to computing grids, server computers, client computers, network data processing system 51 in FIG. 1, and one or more data processing systems and other devices as described with respect to FIG. 1 through FIG. 13. Together, devices and software for implementing the process shown in FIG. 14 can be referred-to as a “system.”

The process begins as the system receives patient data (step 1700). The system establishes connections among received patient data and existing data (step 1702). The system then establishes to which cohorts the patient belongs in order to establish “cohorts of interest” (step 1704). The system then clusters cohorts of interest according to a selected parameter (step 1706). The selected parameter can be any parameter described with respect to FIG. 13, such as but not limited to treatments, treatment effectiveness, patient characteristics, genetic surprisal data, and medical conditions.

The system then determines whether to form additional clusters of cohorts (step 1708). If additional clusters of cohorts are to be formed, then the process returns to step 1706 and repeats.

Additional clusters of cohorts are not to be formed, then the system performs optimization analysis according to ranked parameters (step 1710). The ranked parameters include those parameters described with respect to FIG. 13, and include but are not limited to maximum likely benefit, minimum likely harm, and minimum cost. The system then both presents and stores the results (step 1712).

The system then determines whether to change parameters or parameter rankings (step 1714). A positive determination can be prompted by a medical professional user. For example, a medical professional may reject a result based on his or her professional opinion. A positive determination can also be prompted as a result of not achieving an answer that meets certain criteria or threshold previously input into the system. In any case, if a change in parameters or parameter rankings is to be made, then the system returns to step 1710 and repeats. Otherwise, the system presents and stores the results (step 1716).

The system then determines whether to discontinue the process. A positive determination in this regard can be made in response to medical professional user input that a satisfactory result has been achieved, or that no further processing will achieve a satisfactory result. A positive determination in this regard could also be made in response to a timeout condition, a technical problem in the system, or to a predetermined criteria or threshold.

In any case, if the system is to continue the process, then the system receives new data (step 1720). New data can include the results previously stored in step 1716. New data can include data newly acquired from other databases, such as any of the information sources described with respect to sources of information 1502 of FIG. 12, or data input by a medical professional user that is specifically related to the process at hand. The process then returns to step 1702 and repeats. However, if the process is to be discontinued at step 1718, then the process terminates.

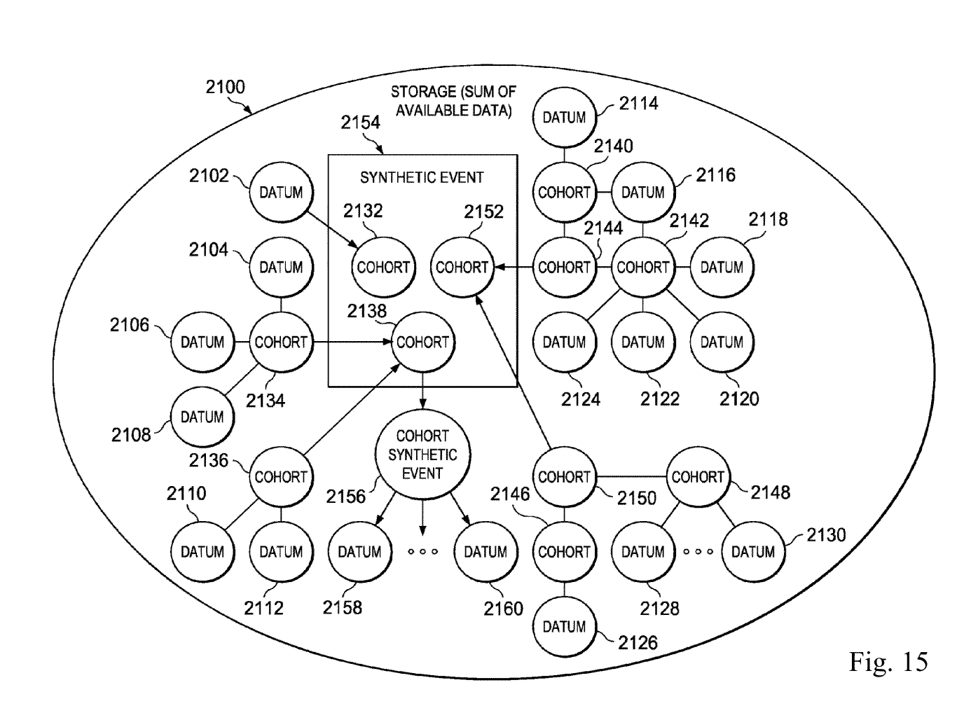

FIG. 15 is a block diagram illustrating combinations of cohorts to generate a synthetic event, in accordance with an illustrative embodiment. Each cohort shown in FIG. 15 can be generated and stored according to the techniques described with respect to FIG. 5 through FIG. 11. The synthetic event shown in FIG. 15 can be calculated using the inference engine.

Before describing combinations of cohorts to generate a synthetic event, several terms are defined. The term “datum” is defined as a single fact represented in a mathematical manner, usually as a binary number. A datum could be one or more bytes. A datum may have associated with it metadata.

The term “cohort” is defined as data that represents a group of individuals, machines, components, or modules identified by a set of one or more common characteristics. A cohort may have associated with it metadata.

An “event” is defined as a particular set of data that represents, encodes, or records at least one of a thing or happening. A happening is some occurrence defined in time, such as but not limited to the fact that a certain boat passed a certain buoy at a certain time. Thus, the term “event” is not used according to its ordinary and customary English meaning.

Events can be processed by computers by processing objects that represent the events. An event object is a set of data arranged into a data structure, such as a vector, row, cube, or some other data structure. A given activity may be represented by more than one event object. Each event object might record different attributes of the activity. Non-limiting examples of “events” include purchase orders, email confirmation of an airline reservation, a stock tick message that reports a stock trade, a message that reports an RFID sensor reading, a medical insurance claim, a healthcare record of a patient, a video recording of a crime, and many, many other examples.

A complex event is defined as an abstraction of other events which are members of the complex event. A complex event can be a cohort, though a cohort need not be a complex event. Examples of complex events include the 1929 stock market crash (an abstraction denoting many thousands of member events, including individual stock trades), a CPU instruction (an abstraction of register transfer level events), a completed stock purchase (an abstraction of the events in a transaction to purchase the stock), a successful on-line shopping cart checkout (an abstraction of shopping cart events on an on-line website), and a school transcript (an abstraction of a record of classes taken by a particular student). Many, many other examples of complex events exist.

A “synthetic event” is defined as an “event” that represents a probability of a future fact or happening, or that represents a probability that a potential past fact or happening has occurred, or that represents a probability that a potential current fact or happening is occurring, with the mathematical formulation of a synthetic event represented by the operation S(p1)==>F(p2), where S is the set of input facts with probability p1 that potentiates future event F with probability p2. Note that future event F in this operation can represent represents a probability that a potential past fact or happening has occurred, or that represents a probability that a potential current fact or happening is occurring, because these probabilities did not exist before a request to calculate them was formulated. Additionally, a synthetic event can be considered a recordable, definable, addressable data interrelationship in solution space, wherein the interrelationship is represented with a surrogate key, and wherein the synthetic event is able to interact with other events or facts for purposes of computer-assisted analysis.

Synthetic events are composed of physically or logically observable events, not suppositions about mental state, unless they can be supported by or characterized as observable fact or numbers. Synthetic events can be compared to generate additional synthetic evens. For example, a previously derived synthetic event is a conclusion that business “B” appears to be entering a market area with probability p1. A second previously derived synthetic event is that, within probability p2, an unknown company is engaging in a large scale hiring of personnel with skill necessary to compete with a particular product line. These two synthetic events can be compared and processed to derive a probability, p3, that business “B” intends to enter into business competition with the particular product line. Other events or synthetic events could be added or combined to the first two previous synthetic events to modify the probability p3.

Returning to FIG. 15, the improved genesis of synthetic events is described. Storage 2100 represents one or more storage units, including RAM, ROM, hard drives, flash disks, or any other form of memory. Storage 2100 contains the sum of data available for processing. As described above, data is preferably stored at the atomic level, meaning that each individual datum is addressable and recordable and has associated with it metadata that allows meaningful manipulation of the data. Any given amount of data can exist within storage 2100, though in this example storage 2100 includes datum 2102, datum 2104, datum 2106, datum 2108, datum 2110, datum 2112, datum 2114, datum 2116, datum 2118, datum 2120, datum 2122, datum 2124, datum 2126, datum 2128, and datum 2130, which are all present before the creation of a synthetic event.

A cohort analyzer, such as cohort analyzer 1604 of FIG. 13, can group these data into cohorts. A cohort can comprise a single datum, such as for example in the case of cohort 2132, which includes datum 2102. Cohort 2132 is different from datum 2102 in that cohort 2132 includes additional data that makes it a potential grouping if at least one additional datum is included in cohort 2132. For example, only a single patient in a study is known to be infected with a virus type that causes acquired immune deficiency syndrome (AIDS). However, a researcher or a computer program can establish a cohort that includes “the set of all patients in the study that have the virus type that causes AIDS.” For the moment, cohort 2132 includes only one member, but additional members could be added. Thus, cohort 2132 is different than datum 2102 alone.

As implied above, multiple datums (data) can be represented as a single cohort. Thus, for example, datum 2104, datum 2106, and datum 2108 together are part of cohort 2134. Likewise, datum 2110 and 2112 together are part of cohort 2136. Similarly, datum 2114 and datum 2116 together are part of cohort 2140; and datum 2118, datum 2120, datum 2122, and datum 2124 together are part of cohort 2142. A cohort, such as cohort 2148 can include a vast plurality of data, as represented by the ellipsis between datum 2128 and datum 2130. Finally, datum 2126 is part of cohort 2146.

To add additional levels of abstraction, cohorts can themselves be combined into broader cohorts. For example, cohort 2134 is combined with cohort 2136 to form cohort 2138. As a specific example, cohort 2138 could be “cancer,” with cohort 2134 representing incidents of colon cancer and cohort 2136 representing incidents of pancreatic cancer.

Many levels of cohorts and abstraction are possible. For example, cohort 2140 and cohort 2142 combine to form cohort 2144. Cohort 2146 and cohort 2148 combine to form cohort 2150. Thereafter, cohort 2144 and cohort 2150 are themselves combined to form cohort 2152.

Each cohort is considered an “event.” Each cohort, or event, is represented as a pointer which points back to the individual members of the cohort; in other words, each cohort is represented as a pointer which points back to each cohort, datum, or other event that forms the cohort. As a result, a single cohort can be processed as a single pointer, even if the pointer points to billions of subcomponents. Each pointer is fully addressable in a computer; thus, each cohort or other event is fully addressable in a computer.

Because each cohort can be processed as a single pointer, even cohorts having billions, trillions, or more members can be processed as a single pointer. For this reason, computationally explosive computations become manageable.

In the illustrative embodiment of FIG. 15, cohort 2132, cohort 2138, and cohort 2152 are to be analyzed to generate synthetic event 2154. An example of an analysis is the generation of generate synthetic event 2154 according to the formula S(p1)==>F(p2), as further described above.

As a result of the generation of generate synthetic event 2154, cohort 2156 is formed. In an illustrative embodiment, cohort 2156 is the synthetic event. However, generate synthetic event 2154 could be composed of multiple cohorts, of which cohort 2156 is a member. Thus, cohort 2156 is a result of the analysis performed on the group comprising cohort 2132, cohort 2138, and cohort 2152.

Cohort 2156 itself is a pointer that refers to sub-members or sub-components related to the analysis. The sub-members of cohort 2156 are derived from the members of cohort 2132, cohort 2138, and cohort 2152. Thus, cohort 2156 can be conceivably composed of a vast plurality of sub-members. In this case, cohort 2156 includes datum 2158 through datum 2160, together with many data represented by the ellipsis. Preferably, not all of the sub-members of cohort 2132, cohort 2138, and cohort 2152 are also sub-members of cohort 2156. Part of the effort of the analysis that generates generate synthetic event 2154 is to narrow the realm of relevant data in order to render computationally explosive calculations amenable to numerical solutions.

Additionally, cohort 2156 can itself be a pointer that points to other cohorts. Thus, for example, cohort 2156 could have a pointer structure similar to the pointer structure that forms cohort 2152.

Because each event or cohort is represented as a pointer, extremely specific information can be obtained. For example, cohort 2132 represents a genetic sequence of a particular patient, cohort 2138 represents a pool of genetic sequences, and cohort 2152 represents diet habits of a particular ethnic group. An inference analysis is performed with the goal of determining a probability that the particular patient will develop a form of cancer in his or her lifetime. In this illustrative embodiment, cohort 2156 could be the group of individuals that are likely to develop cancer, with datum 2158 representing the individual patient in question. Thus, a doctor, researcher, or analyst can “drill down” to achieve reliable conclusions regarding specific items or individuals based on an analysis of a truly vast body of data.

The illustrative embodiments can be described by way of a specific, non-limiting example of a problem to be solved and the implemented solution. The following examples are only provided as an aid to understanding the illustrative embodiments, not to limiting them.

A group of medical researchers are interested in determining if an ethnic diet interacts with genetic background to increase incidents of heart attacks. First, data is collected regarding individual persons who report eating specific ethnic foods to create an “ethnic food” event. The ethnic food events includes items such as chicken fried steak, ribs, pizza with cheese and meat toppings, deep fat fried cheese sticks, and fried candy bars. Additional data is collected from medical literature to find documented clusters of genes indicative of specific geographic origins. These clusters of gene patterns are used to define “geographic gene cluster” events. For example, information can be obtained from the IBM/National Geographic Worldwide Geographic Project to determine indicative clusters. Individual persons are assigned to specific clusters, such as Asian-Chinese, Asian-Japanese, European-Arctic Circle, European-Mediterranean, and others.

Next, individual persons are assigned to “Ultraviolet Light (UV) exposure” events, or cohorts, using individual personal logs and the typical UV exposures for their location of residence. This information is used to create synthetic events called “UV exposure events,” which will measure and rank probable severity of exposure for each individual.

Next, data is obtained about drugs that are currently known to affect heart frequency. Data is also obtained regarding the drug usage history of individual persons using personal logs, insurance payments for drugs, recorded prescriptions for drugs, or personally reported information. Individual persons are then identified with synthetic drug events, such as “analgesic—aspirin,” “analgesic—generic,” “statins—LIPITOR®”, statins—ZOCOR®,” “statins—generic,” and “statins—unknown.” The “statin” events, or cohorts, are then adjusted to be equivalent to a LIPITOR® equivalent dosage, which would itself compose a “LIPITOR®. equivalent” event, or cohort. At this point, these drugs can be analyzed at a generic, name specific, or equivalent dosage level of detail.

Next, persons in the study group that have died are identified, with the cause of death determined from retrieved death certificates. If the cause of death is “heart related,” then those deceased persons would be added to a user-generated synthetic event called “cardio mortalities.” All other deaths are assigned to a user-generated synthetic event called “non-cardio mortalities.” All other participants would be assigned to a third user-generated event called “living participants.”

At this point, a statistical analysis is performed to accept or reject the null hypothesis that consumption of the defined ethnic foods has no effect on the “cardio mortalities” synthetic event. The result is, itself, a computer-generated synthetic event, or cohort. Assume that the null hypothesis is false; in other words, that the consumption of the defined ethnic foods does have an effect on the cardio mortalities synthetic event. In this case, the generated synthetic event can be analyzed in further detail to glean additional detail regarding not only a probability of the truth of the converse positive hypothesis (that the ethnic foods do cause heart-related deaths), but also to determine why those foods cause the heart attacks based on genetic factors.

As more synthetic events are generated, user feedback provided, and as additional raw data become available, the analysis process can be iterated many times until a reliable and accurate answer is achieved. As a result, a truly vast amount of data can be analyzed to find conclusions and reasons for why the conclusions are true or false. The conclusions can be extremely specific, even down to the individual patient level.

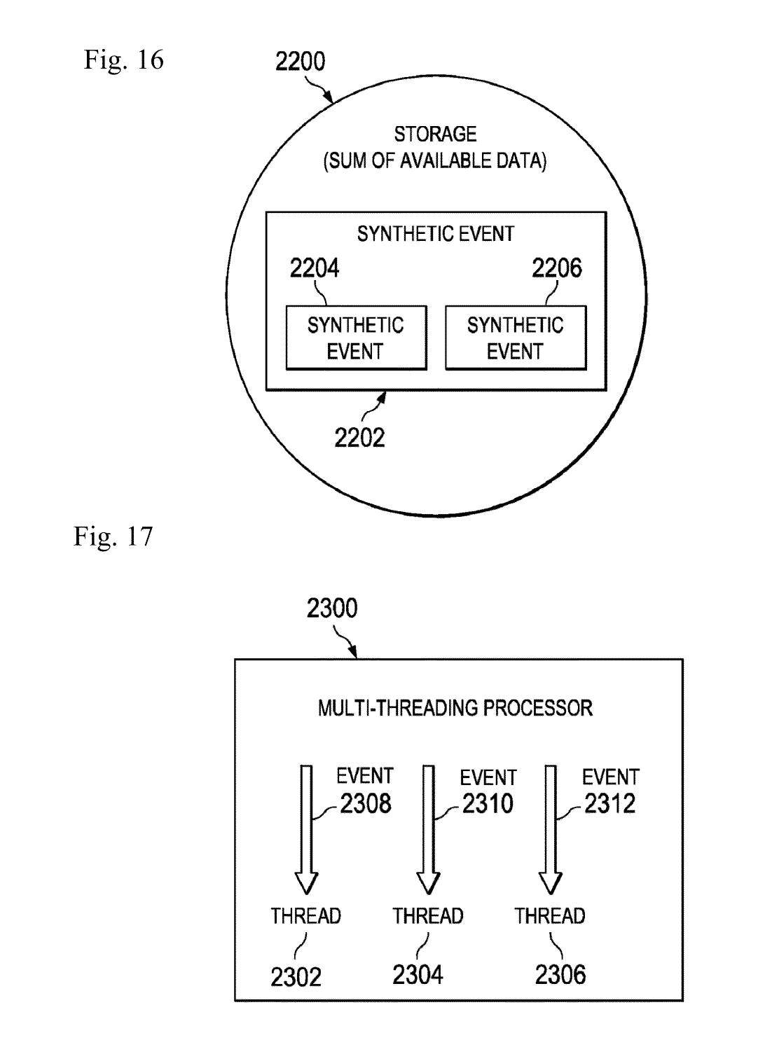

FIG. 16 is a block diagram illustrating a combination of synthetic events, in accordance with an illustrative embodiment. The synthetic events shown in FIG. 16 are calculated in a manner similar to that presented with respect to FIG. 15. Storage 2200 is similar to storage 2100 in FIG. 15, which represents the storage devices that contain the sum of available data.

FIG. 16 shows that additional synthetic events can be generated by combining other synthetic events. Thus, based on storage 2200, synthetic event 2202 can be generated by combining and/or analyzing synthetic event 2204 and synthetic event 2206. The resulting synthetic event 2202 is reported and then stored for future analysis.

FIG. 17 is a block diagram illustrating processing of events in a processor having multi-threading processing capability, in accordance with an illustrative embodiment. Processor 2300 can be one or more processors acting together to provide multi-threading functionality. Multi-threading functionality is often provided by parallel-processing processors.

Processor 2300 can be used to more quickly perform synthetic event analysis, as described with respect to FIG. 15. Specifically, each thread, thread 2302, thread 2304, and thread 2306 processes a corresponding distinct event. Thus, thread 2302 processes event 2308, thread 2304 processes event 2310, and thread 2306 processes event 2312. Because each event is processed by a different thread, the entire process of performing analysis is increased. Further, as events or cohorts are combined into broader events or cohorts, the number of threads operating can be decreased. Still further, two or more threads could process different aspects of a single event, thereby further increasing the speed of processing.

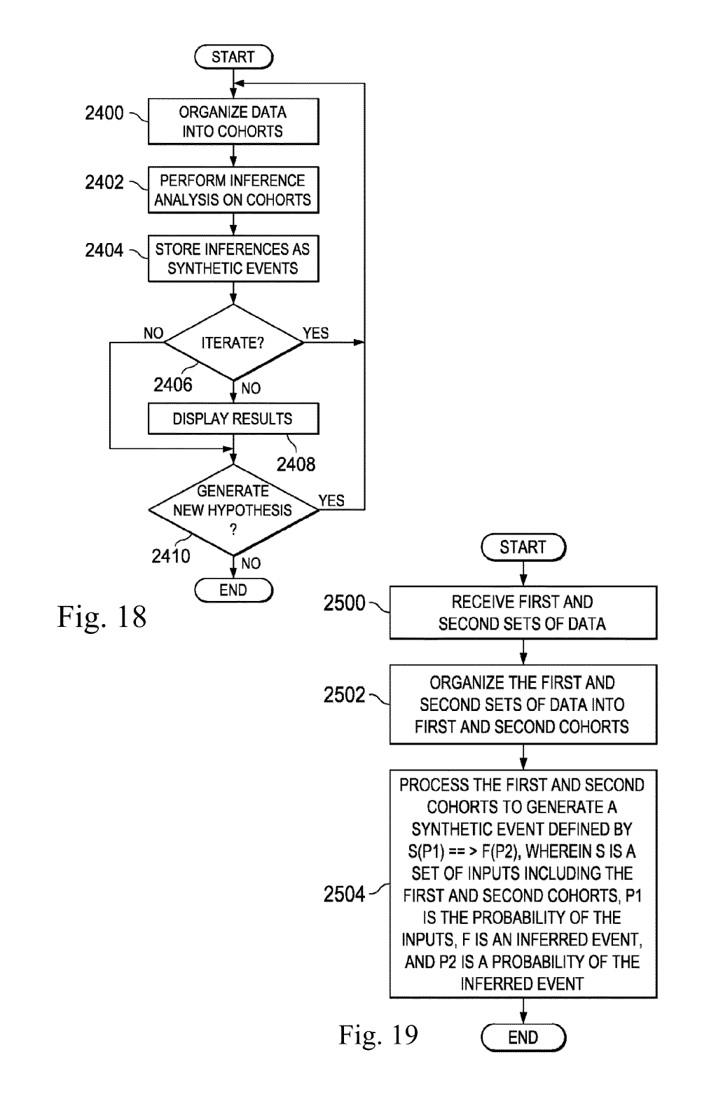

FIG. 18 is a flowchart of a process for generating synthetic events, in accordance with an illustrative embodiment. The process shown in FIG. 18 represents a process performed to calculate a synthetic event, such as the synthetic events shown in FIGS. 15 and 16. The process shown in FIG. 18 can be implemented using dynamic analytical framework 1500 in FIG. 12, and dynamic analytical framework 1600 in FIG. 13.

The process begins as the system organizes data into cohorts (step 2400). The system then performs inference analysis on the cohorts (step 2402). The system then stores the inferences as synthetic events (step 2404) as shown in step 110 of FIG. 3.

The system determines whether the process should be iterated (step 2406). The decision to iterate can be made responsive to either user feedback or to a policy or rules-based determination by a computer that further iteration is needed or desired. Examples of cases that require or should be subject to further iteration include, synthetic events that are flawed for one reason or another, synthetic events that do not have a stable probability (i.e., a small change in initial conditions results in a large variation in probability), the addition of new raw data, the addition of some other synthetic event, or many other examples.

If iteration is to be performed, then the process returns to step 2400 and repeats. Otherwise, the system takes the parallel steps of displaying results (step 2408) and determining whether to generate a new hypothesis (step 2410). A determination of a new hypothesis can be either user-initiated or computer-generated based on rules or policies. A new hypothesis can be considered an event or a fact established as the basis of a query.

If a new hypothesis is to be generated, then the process returns to step 2400 and repeats. Otherwise, the process terminates.

FIG. 19 is a flowchart of a process for generating synthetic events, in accordance with an illustrative embodiment. The process shown in FIG. 19 represents a process performed to calculate a synthetic event, such as the synthetic events shown in FIGS. 15 and 16. The process shown in FIG. 19 can be implemented using dynamic analytical framework 1500 in FIG. 12, and dynamic analytical framework 1600 in FIG. 13.

The process begins as the system receives first and second sets of data (step 2500). The system organizes the first and second sets of data into first and second cohorts (step 2502). The system finally processes the first and second cohorts to generate a synthetic event defined by S(p1)==>F(p2), wherein S is a set of inputs including the first and second cohorts, p1 is the probability of the inputs, F is an inferred event, and p2 is a probability of the inferred event (step 2504). The process terminates thereafter.

Thus, the illustrative embodiments provide for a computer implemented method, data processing system, and computer program product for generating synthetic events based on a vast amount of data are provided. A first set of data is received. A second set of data different than the first set of data is received. The first set of data is organized into a first cohort. The second set of data is organized into a second cohort. The first cohort and the second cohort are processed to generate a synthetic event. The synthetic event comprises a third set of data representing a result of a mathematical computation defined by the operation S(p1)==>F(p2), wherein S comprises a set of input facts with probability p1, wherein the set of input facts comprise the first cohort and the second cohort, and wherein F comprises an inferred event with probability p2. The term “event” means a particular set of data that represents, encodes, or records at least one of a thing or happening. Each of the first set of data, the second set of data, the first cohort, the second cohort, the synthetic event, and subcomponents thereof all comprise different events. The synthetic event is stored.

In another illustrative embodiment, each corresponding event of the different events is represented as a corresponding pointer. Each corresponding subcomponent of an event is represented as an additional corresponding pointer.

In another illustrative embodiment, performing inference analysis includes performing calculations regarding the first cohort using a first thread executing on a processor having multi-threading functionality and performing calculations regarding the second cohort using a second thread executing on the processor. In still another illustrative embodiment, the first cohort comprises a plurality of data and the second cohort comprises a single datum.

In another illustrative embodiment, the first cohort is derived from a first set of sub-cohorts and wherein the second cohort is derived from a second set of sub-cohorts. In yet another illustrative embodiment, directly comparing the first set of data to the second set of data results in computationally explosive processing. In this illustrative embodiment, the first set of data can represent corresponding gene patterns of corresponding patients in a set of humans, and the second set of data can represent gene patterns of a second set of humans.

The illustrative embodiments can include receiving a third set of data, organizing the third set of data into a third cohort, organizing the synthetic event into a fourth cohort, and processing the first cohort, the second cohort, the third cohort, and the fourth cohort to generate a second synthetic event. The second synthetic event is stored.

This illustrative embodiment can also include processing the first synthetic event and the second synthetic event to generate a third synthetic event. The third synthetic event can also be stored.

In another illustrative embodiment, the first set of data represents gene patterns of individual patients, the second set of data represents diet patterns of a population of individuals in a geographical location, the third set of data represents health records of the individual patients, and the synthetic event represents a probability of that a sub-population of particular ethnic origin will develop cancer. The second synthetic event comprises a probability that the individual patients will develop cancer.

In this particular illustrative embodiment, processing the first synthetic event and the second synthetic event generate a third synthetic event, which can be stored. The third synthetic event can comprise a probability that a specific patient in the individual patients will develop cancer.

FIG. 20 illustrates internal and external components of client computer 52 and server computer 54 in which illustrative embodiments may be implemented. In FIG. 20, client computer 52 and server computer 54 include respective sets of internal components 70a, 70b, and external components 90a, 90b. Each of the sets of internal components 70a, 70b includes one or more processors 72, one or more computer-readable RAMs 74 and one or more computer-readable ROMs 76 on one or more buses 78, and one or more operating systems 80 and one or more computer-readable tangible storage devices 82. The one or more operating systems 80, sequence to reference genome compare program 67, a reference genome creator program 68, and/or a cohort system program 66 are stored on one or more of the computer-readable tangible storage devices 82 for execution by one or more of the processors 72 via one or more of the RAMs 74 (which typically include cache memory). In the embodiment illustrated in FIG. 20, each of the computer-readable tangible storage devices 82 is a magnetic disk storage device of an internal hard drive. Alternatively, each of the computer-readable tangible storage devices 82 is a semiconductor storage device such as ROM 76, EPROM, flash memory or any other computer-readable tangible storage device that can store a computer program and digital information.

Each set of internal components 70a, 70b also includes a R/W drive or interface 86 to read from and write to one or more portable computer-readable tangible storage devices 98 such as a CD-ROM, DVD, memory stick, magnetic tape, magnetic disk, optical disk or semiconductor storage device. A sequence to reference genome compare program 67, a reference genome creator program 68, and/or a cohort system program 66 can be stored on one or more of the portable computer-readable tangible storage devices 98, read via R/W drive or interface 86 and loaded into hard drive 82.

Each set of internal components 70a, 70b also includes a network adapter or interface 86 such as a TCP/IP adapter card. A sequence to reference genome compare program 67, a reference genome creator program 68, and/or a cohort system program 66 can be downloaded to client computer 52 and server computer 54 from an external computer via a network (for example, the Internet, a local area network or other, wide area network) and network adapter or interface 86. From the network adapter or interface 86, a sequence to reference genome compare program 67, a reference genome creator program 68, and/or a cohort system program 66 are loaded into hard drive 82. The network may comprise copper wires, optical fibers, wireless transmission, routers, firewalls, switches, gateway computers and/or edge servers.

Each of the sets of external components 90a, 90b includes a computer display monitor 92, a keyboard 94, and a computer mouse 96. Each of the sets of internal components 70a, 70b also includes device drivers 84 to interface to computer display monitor 92, keyboard 94 and computer mouse 96. The device drivers 84, R/W drive or interface 86 and network adapter or interface 86 comprise hardware and software (stored in storage device 82 and/or ROM 76).

A sequence to reference genome compare program 67, a reference genome creator program 68, and/or a cohort system program 66 can be written in various programming languages including low-level, high-level, object-oriented or non object-oriented languages. Alternatively, the functions of a sequence to reference genome compare program 67, a reference genome creator program 68, and/or a cohort system program 66 can be implemented in whole or in part by computer circuits and other hardware (not shown).

Based on the foregoing, a computer system, method and program product have been disclosed for creating synthetic events using genetic surprisal data representing a genetic sequence of an organism with an addition of context. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of creating synthetic events using genetic surprisal data representing a genetic sequence of an organism with an addition of context comprising the steps of:
a computer retrieving genetic surprisal data from at least two organisms from a repository and an indication of a reference genome used to obtain the genetic surprisal data;
if the reference genome used to generate the genetic surprisal data for each of the at least two organisms is different:
the computer retrieving each of the reference genomes and dividing each of the reference genomes into pieces corresponding to the genetic surprisal data of the at least two organisms;
the computer combining the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms;
the computer searching the genetic surprisal data for at least one attribute repeated at a frequency within the genetic surprisal data of the at least two organisms and organism records;
the computer optimizing the genetic surprisal data associated with the attribute repeated at a frequency within the genetic surprisal data of the at least two organisms and the organism records through clustering defined by at least one parameter;
the computer forming at least two cohorts, a control cohort and a treatment cohort based on optimization of the genetic surprisal data; and
the computer generating at least one synthetic event from the at least two cohorts.

2. The method of claim 1, further comprising:
a computer comparing nucleotides of the genetic sequence of the organism to nucleotides from a reference genome, to find differences where nucleotides of the genetic sequence of the organism which are different from the nucleotides of the reference genome; and
the computer using the differences to create and store genetic surprisal data in a repository, the genetic surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome and indicating the reference genome used to obtain the differences.

3. The method of claim 2, further comprising a computer receiving at least one sequence of an organism from a source and storing the at least one sequence in a repository.

4. The method of claim 2, further comprising a computer obtaining a reference genome corresponding to the organism and storing the reference genome in a repository.

5. The method of claim 1, in which the genetic surprisal data further comprises a number of differences at the location within the reference genome.

6. The method of claim 1, wherein the step of the computer optimizing the genetic surprisal data associated with the attribute repeated at a frequency within the genetic surprisal data of the at least two organisms and the organism records through clustering defined by at least one parameter comprises:
clustering of treatment records of the organisms after a co-morbidity filter is used to eliminate any records that include one or more co-morbidities which eliminate the records from inclusion in a treatment cohort record cluster to form clustered treatment cohorts.

7. The method of claim 1, wherein the step of the computer forming at least two cohorts, a control cohort and a treatment cohort based on optimization of the genetic surprisal data, comprises:
scoring control cohort records to form potential control cohort members; and
selecting an optimal control cohort by minimizing differences between the potential control cohorts members and clustered treatment cohorts.

8. The method of claim 7, wherein selecting the optimal control cohort is performed by a 0-1 integer programming model.

9. The method of claim 7, wherein scoring control cohort records further comprises scoring all patient records by computing a Euclidean distance to cluster prototypes of all treatment cohorts.

10. The method of claim 1, wherein the attributes are any of features, variables, parameters and characteristics.

11. The method of claim 1, wherein the step of the computer searching the genetic surprisal data for at least one attribute repeated at a frequency within the genetic surprisal data of the at least two organisms and organism records further comprises: searching data regarding the organism to determine attributes that most strongly differentiate assignment of organism records to particular clusters.

12. The method of claim 1, wherein the attributes include gender, age, disease state, nucleotide changes, and physical condition.

13. The method of claim 1, wherein each organism record is scored to calculate the Euclidean distance to all clusters.

14. The method of claim 1, wherein the step of the computer searching the genetic surprisal data for at least one attribute repeated at a frequency within the genetic surprisal data of the at least two organisms and organism records is performed by a data mining application.

15. The method of claim 1, wherein the step of the computer optimizing the genetic surprisal data associated with the attribute repeated at a frequency within the genetic surprisal data of the at least two organisms and the organism records through clustering defined by at least one parameter further comprises: generating a feature map to form the clustered treatment cohorts.

16. The method of claim 15, wherein the feature map is a Kohonen feature map.

17. A computer program product for creating synthetic events using genetic surprisal data representing a genetic sequence of an organism with an addition of context comprising:
one or more computer-readable, tangible storage devices;
program instructions, stored on at least one of the one or more storage devices, to retrieve genetic surprisal data from at least two organisms from a repository and an indication of a reference genome used to obtain the genetic surprisal data;
if the reference genome used to generate the genetic surprisal data for each of the at least two organisms is different:
program instructions, stored on at least one of the one or more storage devices, to retrieve each of the reference genomes and divide each of the reference genomes into pieces corresponding to the genetic surprisal data of the at least two organisms;
program instructions, stored on at least one of the one or more storage devices, to combine the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms;
program instructions, stored on at least one of the one or more storage devices, to search the genetic surprisal data for at least one attribute repeated at a frequency within the genetic surprisal data of the at least two organisms and organism records;
program instructions, stored on at least one of the one or more storage devices, to optimize the genetic surprisal data associated with the attribute repeated at a frequency within the genetic surprisal data of the at least two organisms and the organism records through clustering defined by at least one parameter;
program instructions, stored on at least one of the one or more storage devices, to form at least two cohorts, a control cohort and a treatment cohort based on optimization of the genetic surprisal data; and
program instructions, stored on at least one of the one or more storage devices, to generate at least one synthetic event from the at least two cohorts.

18. The program product of claim 17, further comprising:
program instructions, stored on at least one of the one or more storage devices, to compare nucleotides of the genetic sequence of the organism to nucleotides from a reference genome, to find differences where nucleotides of the genetic sequence of the organism which are different from the nucleotides of the reference genome; and
program instructions, stored on at least one of the one or more storage devices, to use the differences to create and store genetic surprisal data in a repository, the genetic surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome and indicating the reference genome used to obtain the differences.

19. The program product of claim 18, further comprising program instructions, stored on at least one of the one or more storage devices, to receive at least one sequence of an organism from a source and store the at least one sequence in a repository.

20. The program product of claim 18, further comprising program instructions, stored on at least one of the one or more storage devices, to obtain a reference genome corresponding to the organism and store the reference genome in a repository.

21. The program product of claim 17, in which the genetic surprisal data further comprises a number of differences at the location within the reference genome.

22. The program product of claim 17, wherein the program instructions, stored on at least one of the one or more storage devices, to optimize the genetic surprisal data associated with the attribute repeated at a frequency within the genetic surprisal data of the at least two organisms and the organism records through clustering defined by at least one parameter comprises program instructions, stored on at least one of the one or more storage devices, to:
clustering of treatment records of the organisms after a co-morbidity filter is used to eliminate any records that include one or more co-morbidities which eliminate the records from inclusion in a treatment cohort record cluster to form clustered treatment cohorts.

23. The program product of claim 17, wherein the program instructions, stored on at least one of the one or more storage devices, to form at least two cohorts, a control cohort and a treatment cohort based on optimization of the genetic surprisal data, comprises program instructions, stored on at least one of the one or more storage devices, to:
scoring control cohort records to form potential control cohort members; and
selecting an optimal control cohort by minimizing differences between the potential control cohorts members and clustered treatment cohorts.

24. The program product of claim 23, wherein selecting the optimal control cohort is performed by a 0-1 integer programming model.

25. The program product of claim 23, wherein scoring control cohort records further comprises program instructions, stored on at least one of the one or more storage devices, to score all patient records by computing a Euclidean distance to cluster prototypes of all treatment cohorts.

26. The program product of claim 17, wherein the attributes are any of features, variables, parameters and characteristics.

27. The program product of claim 17, wherein the program instructions, stored on at least one of the one or more storage devices, to search the genetic surprisal data for at least one attribute repeated at a frequency within the genetic surprisal data of the at least two organisms and organism records further comprises program instructions, stored on at least one of the one or more storage devices, to search data regarding the organism to determine attributes that most strongly differentiate assignment of organism records to particular clusters.

28. The program product of claim 17, wherein the attributes include gender, age, disease state, nucleotide changes, and physical condition.

29. The program product of claim 17, wherein each organism record is scored to calculate the Euclidean distance to all clusters.

30. The program product of claim 17, wherein the program instructions, stored on at least one of the one or more storage devices, to search the genetic surprisal data for at least one attribute repeated at a frequency within the genetic surprisal data of the at least two organisms and organism records is performed by a data mining application.

31. The program product of claim 17, wherein the program instructions, stored on at least one of the one or more storage devices, to optimize the genetic surprisal data associated with the attribute repeated at a frequency within the genetic surprisal data of the at least two organisms and the organism records through clustering defined by at least one parameter further comprises: generating a feature map to form the clustered treatment cohorts.

32. The program product of claim 31, wherein the feature map is a Kohonen feature map.

33. A computer system for creating synthetic events using genetic surprisal data representing a genetic sequence of an organism with an addition of context comprising:
one or more processors, one or more computer-readable memories and one or more computer-readable, tangible storage devices;
program instructions, stored on at least one of the one or more storage devices for execution by at least one of the one or more processors via at least one of the one or more memories, to retrieve genetic surprisal data from at least two organisms from a repository and an indication of a reference genome used to obtain the genetic surprisal data;
if the reference genome used to generate the genetic surprisal data for each of the at least two organisms is different:
program instructions, stored on at least one of the one or more storage devices for execution by at least one of the one or more processors via at least one of the one or more memories, to retrieve each of the reference genomes and divide each of the reference genomes into pieces corresponding to the genetic surprisal data of the at least two organisms;
program instructions, stored on at least one of the one or more storage devices for execution by at least one of the one or more processors via at least one of the one or more memories, to combine the pieces of the reference genomes together to form a single reference genome, wherein when nucleotides of the genetic sequence of the at least two organisms are compared to nucleotides from the single reference genome, the differences where nucleotides of the genetic sequence of the organisms which are different from the nucleotides of the single reference genome results in surprisal data of the at least two organisms;
program instructions, stored on at least one of the one or more storage devices for execution by at least one of the one or more processors via at least one of the one or more memories, to search the genetic surprisal data for at least one attribute repeated at a frequency within the genetic surprisal data of the at least two organisms and organism records;
program instructions, stored on at least one of the one or more storage devices for execution by at least one of the one or more processors via at least one of the one or more memories, to optimize the genetic surprisal data associated with the attribute repeated at a frequency within the genetic surprisal data of the at least two organisms and the organism records through clustering defined by at least one parameter;
program instructions, stored on at least one of the one or more storage devices for execution by at least one of the one or more processors via at least one of the one or more memories, to form at least two cohorts, a control cohort and a treatment cohort based on optimization of the genetic surprisal data; and
program instructions, stored on at least one of the one or more storage devices for execution by at least one of the one or more processors via at least one of the one or more memories, to generate at least one synthetic event from the at least two cohorts.

34. The system of claim 33, further comprising:
program instructions, stored on at least one of the one or more storage devices for execution by at least one of the one or more processors via at least one of the one or more memories, to compare nucleotides of the genetic sequence of the organism to nucleotides from a reference genome, to find differences where nucleotides of the genetic sequence of the organism which are different from the nucleotides of the reference genome; and
program instructions, stored on at least one of the one or more storage devices for execution by at least one of the one or more processors via at least one of the one or more memories, to use the differences to create and store genetic surprisal data in a repository, the genetic surprisal data comprising a starting location of the differences within the reference genome, and the nucleotides from the genetic sequence of the organism which are different from the nucleotides of the reference genome, discarding sequences of nucleotides that are the same in the genetic sequence of the organism and the reference genome and indicating the reference genome used to obtain the differences.

35. The system of claim 34, further comprising program instructions, stored on at least one of the one or more storage devices for execution by at least one of the one or more processors via at least one of the one or more memories, to receive at least one sequence of an organism from a source and store the at least one sequence in a repository.

36. The system of claim 34, further comprising program instructions, stored on at least one of the one or more storage devices for execution by at least one of the one or more processors via at least one of the one or more memories, to obtain a reference genome corresponding to the organism and store the reference genome in a repository.

37. The system of claim 33, in which the genetic surprisal data further comprises a number of differences at the location within the reference genome.

38. The system of claim 33, wherein the program instructions, stored on at least one of the one or more storage devices for execution by at least one of the one or more processors via at least one of the one or more memories, to optimize the genetic surprisal data associated with the attribute repeated at a frequency within the genetic surprisal data of the at least two organisms and the organism records through clustering defined by at least one parameter comprises program instructions, stored on at least one of the one or more storage devices for execution by at least one of the one or more processors via at least one of the one or more memories, to:
clustering of treatment records of the organisms after a co-morbidity filter is used to eliminate any records that include one or more co-morbidities which eliminate the records from inclusion in a treatment cohort record cluster to form clustered treatment cohorts.

39. The system of claim 33, wherein the program instructions, stored on at least one of the one or more storage devices for execution by at least one of the one or more processors via at least one of the one or more memories, to form at least two cohorts, a control cohort and a treatment cohort based on optimization of the genetic surprisal data, comprises program instructions, stored on at least one of the one or more storage devices for execution by at least one of the one or more processors via at least one of the one or more memories, to:
scoring control cohort records to form potential control cohort members; and
selecting an optimal control cohort by minimizing differences between the potential control cohorts members and clustered treatment cohorts.

40. The system of claim 39, wherein selecting the optimal control cohort is performed by a 0-1 integer programming model.

41. The system of claim 39, wherein scoring control cohort records further comprises program instructions, stored on at least one of the one or more storage devices for execution by at least one of the one or more processors via at least one of the one or more memories, to score all patient records by computing a Euclidean distance to cluster prototypes of all treatment cohorts.

42. The system of claim 33, wherein the attributes are any of features, variables, parameters and characteristics.

43. The system of claim 33, wherein the program instructions, stored on at least one of the one or more storage devices for execution by at least one of the one or more processors via at least one of the one or more memories, to search the genetic surprisal data for at least one attribute repeated at a frequency within the genetic surprisal data of the at least two organisms and organism records further comprises program instructions, stored on at least one of the one or more storage devices for execution by at least one of the one or more processors via at least one of the one or more memories, to search data regarding the organism to determine attributes that most strongly differentiate assignment of organism records to particular clusters.

44. The system of claim 33, wherein the attributes include gender, age, disease state, nucleotide changes, and physical condition.

45. The system of claim 33, wherein each organism record is scored to calculate the Euclidean distance to all clusters.

46. The system of claim 33, wherein the program instructions, stored on at least one of the one or more storage devices for execution by at least one of the one or more processors via at least one of the one or more memories, to search the genetic surprisal data for at least one attribute repeated at a frequency within the genetic surprisal data of the at least two organisms and organism records is performed by a data mining application.

47. The system of claim 33, wherein the program instructions, stored on at least one of the one or more storage devices for execution by at least one of the one or more processors via at least one of the one or more memories, to optimize the genetic surprisal data associated with the attribute repeated at a frequency within the genetic surprisal data of the at least two organisms and the organism records through clustering defined by at least one parameter further comprises: generating a feature map to form the clustered treatment cohorts.
